(19) United States
(12) Patent Application Publication
(10) Pub. No.: US 2012/0183811 A1
(43) Pub. Date: Jul. 19, 2012

(54) MAGNETIC RECORDING MEDIUM

(75) Inventors: Yasushi HATTORI, Minami-ashigara-shi (JP); Ryota SUZUKI, Minami-ashigara-shi (JP); Norihito KASADA, Minami-ashigara-shi (JP)

(73) Assignee: FUJIFILM CORPORATION, Tokyo (JP)

(21) Appl. No.: 13/352,004

(22) Filed: Jan. 17, 2012

(30) Foreign Application Priority Data
Jan. 17, 2011 (JP) 2011-006556
Oct. 31, 2011 (JP) 2011-239571

(51) Int. Cl. G11B 5/65

(52) U.S. Cl. 428/836

(57) ABSTRACT

An aspect of the present invention relates to a magnetic recording medium comprising a magnetic layer containing a ferromagnetic powder and a binder on a nonmagnetic support, wherein the ferromagnetic powder is comprised of magnetic particles comprising a hard magnetic particle and a soft magnetic material deposited on a surface of the hard magnetic particle in a state where the soft magnetic material is exchange-coupled with the hard magnetic particle.

### CROSS-REFERENCE TO RELATED APPLICATIONS

This application claims the benefit of priority under 35 USC 119 to Japanese Patent Application No. 2011-006556 filed on Jan. 17, 2011 and Japanese Patent Application No. 2011-239571 filed on Oct. 31, 2011, which are expressly incorporated herein by reference in their entirety.

### BACKGROUND OF THE INVENTION

1. Field of the Invention

The present invention relates to a magnetic recording medium, and more particularly, to a particulate magnetic recording medium affording both good recording properties and high reliability.

2. Discussion of the Background

Due to increases in the quantity of information being recorded, higher density recording is being constantly demanded of the magnetic recording media widely employed as video tapes, computer tapes, and disks. However, when the magnetic particles contained in the magnetic recording layer of a magnetic recording medium are of poor thermal stability, the energy that maintains the direction of magnetization of the magnetic particles (the magnetic energy) cannot readily counter thermal energy, and the information that has been recorded attenuates over time (magnetic attenuation), ultimately compromising the reliability of the reproduced signal. Accordingly, the use of magnetic particles of good thermal stability is required to raise the reliability of a magnetic recording medium.

By contrast, materials of high crystal magnetic anisotropy have good thermal stability due to a high potential for thermal stability. Accordingly, research has been conducted into materials of high crystal magnetic anisotropy as magnetic materials of good thermal stability. For example, high crystal magnetic anisotropy has been achieved by adding Pt to a CoCr-based magnetic material in hard disks (HD) and the like. Investigation has also been conducted into the use of CoPt, FePd, FePt, and the like as magnetic materials of higher crystal magnetic anisotropy. Further, magnetic materials containing rare earth elements, such as SmCo, NdFeB, and SmFeN, are known to be magnetic materials that do not contain expensive Pt, that are inexpensive, and that exhibit high crystal magnetic anisotropy (referred to as “Technique 1”, hereinafter).

Although materials of high crystal magnetic anisotropy afford good thermal stability, an increase in the switching magnetic field necessitates a large external magnetic field for recording, compromising recording properties. Accordingly, the Journal of the Magnetics Society of Japan 29, 239-242 (2005), which is expressly incorporated herein by reference in its entirety, describes attempts that have been made to reduce the switching magnetic field by stacking a soft magnetic layer and a hard magnetic layer formed as vapor phase films on a nonmagnetic inorganic material to produce exchange coupling interaction (referred to as “Technique 2”, hereinafter).

In metal thin-film magnetic recording media such as HD media, a glass substrate capable of withstanding high temperatures during vapor deposition is normally employed as the support. By contrast, particulate magnetic recording media affording good general-purpose properties and employing inexpensive organic material supports have been proposed in recent years, and are widely employed as video tapes, computer tapes, flexible disks, and the like. From the perspective of maintaining the general-purpose properties of such particulate media, it is difficult in practical terms to employ a magnetic material in which expensive Pt is used. Thus, the use of a magnetic material comprising a rare earth element such as in Technique 1 is conceivable. However, as set forth above, improvement of recording properties is required for magnetic materials of high crystal magnetic anisotropy. By contrast, it is difficult to apply Technique 2 to particulate magnetic recording media for the purpose of improvement of recording properties. The reason is that it is practically impossible to apply Technique 2 to nonmagnetic organic material supports usually employed in particulate magnetic recording media because these supports are of poorer heat resistance.

As set forth above, it is difficult to provide a particulate magnetic recording medium affording good recording properties using magnetic particles of high thermal stability with the conventional art.

### SUMMARY OF THE INVENTION

Accordingly, an aspect of the present invention provides for a particulate magnetic recording medium affording good recording properties and containing magnetic particles of high thermal stability in a magnetic layer.

The present inventors conducted extensive research into achieving the above magnetic recording medium. As a result, they discovered that magnetic particles comprising a hard magnetic particle and a soft magnetic material deposited on a surface of the hard magnetic particle in a state where the soft magnetic material is exchange-coupled with the hard magnetic particle. This was attributed to the following.

Exchange-coupling a soft magnetic material (also referred to as a “soft magnetic phase” hereinafter) to the surface of a hard magnetic particle (also referred to as a “hard magnetic phase” or “hard magnetic material” hereinafter) having high crystal magnetic anisotropy (a high Ku) results in the soft magnetic phase responding first to changes in the external magnetic field, changing the orientation of the spin of the soft magnetic phase. That makes it possible to change the orientation of spin of the hard magnetic phase that is exchange-coupled with the soft magnetic phase, permitting a lower switching magnetic field while maintaining the thermal stability of the hard magnetic particle in the magnetic particle. As a result, it becomes possible to achieve good recording properties in a magnetic layer containing magnetic particles of high thermal stability.

The present invention was devised on that basis.

An aspect of the present invention relates to a magnetic recording medium comprising a magnetic layer containing a ferromagnetic powder and a binder on a nonmagnetic support, wherein

the ferromagnetic powder is comprised of magnetic particles comprising a hard magnetic particle and a soft magnetic material deposited on a surface of the hard magnetic particle in a state where the soft magnetic material is exchange-coupled with the hard magnetic particle.

The magnetic particle may have a coercive force in a range of equal to or higher than 80 kA/m but less than 240 kA/m.

The magnetic particle may have a saturation magnetization ranging from 4.0×10⁻² to 2.2 A·m²/g.

In an embodiment, a carbon component may be present over the hard magnetic particle on which the soft magnetic material is deposited. The carbon component may be present in an outermost layer of the magnetic particle.

In another embodiment, the magnetic particle may be a magnetic particle in which no peak derived from a carbon component is detected by X-ray diffraction analysis.

The magnetic layer may further comprise a component which lowers a coefficient of friction.

The component which lowers a coefficient of friction may be a nonmagnetic inorganic particle, and the magnetic layer may further comprise an aromatic compound containing an aromatic ring in which a substituent selected from the group consisting of a hydroxyl group and a carboxyl group is directly substituted onto the aromatic ring.

The magnetic layer may comprise no carbon black.

The magnetic layer may further comprise a granular substance other than a carbon black. The above granular substance is different from the nonmagnetic inorganic particle.

The nonmagnetic inorganic particle may be an inorganic oxide colloidal particle.

The inorganic oxide colloidal particle may be a silica colloidal particle.

The aromatic compound may comprise one aromatic ring per molecule.

The aromatic ring contained in the aromatic compound may be a naphthalene ring or a biphenyl ring.

The number of the substituent which is substituted onto the aromatic ring contained in the aromatic compound may be one or two.

The aromatic compound may be dihydroxynaphthalene.

The magnetic powder may have an oxide layer over the hard magnetic particle on which the soft magnetic material is deposited.

The hard magnetic particle may be hexagonal ferrite.

The soft magnetic material may comprise a transition metal and a compound of a transition metal and oxygen.

The compound may comprise no alkaline earth metal.

The transition metal contained in the compound may be cobalt.

The above compound may be CoHO₂.

The present invention makes it possible to achieve good recording properties in a magnetic recording medium exhibiting high reliability by incorporating magnetic powder of high thermal stability into the magnetic layer.

Other exemplary embodiments and advantages of the present invention may be ascertained by reviewing the present disclosure and the accompanying drawing.

### BRIEF DESCRIPTION OF THE DRAWINGS

The present invention will be described in the following text by the exemplary, non-limiting embodiments shown in the figure, wherein:

FIG. 1 shows composition evaluation results by X-ray diffraction of the magnetic particles obtained in Reference Example 13 and starting material barium ferrite particles.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

The present invention relates to a magnetic recording medium comprising a magnetic layer containing a ferromagnetic powder and a binder on a nonmagnetic support. In the magnetic recording medium of the present invention, the ferromagnetic powder is comprised of magnetic particles comprising a hard magnetic particle and a soft magnetic material deposited on a surface of the hard magnetic particle in a state where the soft magnetic material is exchange-coupled with the hard magnetic particle. Thus, it is possible to achieve both good recording properties and high reliability.

The ferromagnetic powder contained in the magnetic layer of the magnetic recording medium of the present invention is comprised of magnetic particles comprising a hard magnetic particle and a soft magnetic material deposited on a surface of the hard magnetic particle in a state where the soft magnetic material is exchange-coupled with the hard magnetic particle. Hard magnetic particles have high crystal magnetic anisotropy and high thermal stability, thereby making it possible to provide a magnetic recording medium of low magnetic attenuation over time and high reliability. However, the coercive force is high due to the high crystal magnetic anisotropy, and the external magnetic field required for recording increases, compromising recording properties.

By contrast, in the above magnetic particles, a soft magnetic material is deposited on the surface of a hard magnetic particle and a state of exchange coupling is induced between the soft magnetic material and the hard magnetic particle. Thus, while maintaining the crystal magnetic anisotropy (high Ku) of the hard magnetic particle, the coercive force of the magnetic particle can be kept at a level suited to recording. The present invention employs such magnetic particles to provide a magnetic recording medium affording both high reliability and good recording properties.

In the present invention, the term “exchange coupling” refers to coupling of a hard magnetic material and a soft magnetic material such that the spin orientation is aligned by exchange interaction, the spin of the hard magnetic material and the spin of the soft magnetic region operate in concerted fashion, and the orientation of the spin changes as a single magnetic material. When a soft magnetic phase is present on the surface of a hard magnetic phase without undergoing exchange coupling, that is, is simply physically attached, the coercive force of the hard magnetic material will not change depending on the presence or absence of the soft magnetic phase. Accordingly, the fact that a hard magnetic phase and a soft magnetic phase have exchange-coupled can be confirmed based on whether or not the coercive force of the hard magnetic material is reduced by formation of the soft magnetic phase. Further, when a soft magnetic phase is present on the surface of a hard magnetic phase without undergoing exchange coupling, the M-H loop (hysteresis loop) becomes the sum of the M-H loop of the soft magnetic phase with the M-H loop of the hard magnetic phase. Thus, in places corresponding to the coercive force of the soft magnetic phase, segments appear in the M-H loop. Accordingly, exchange coupling of a hard magnetic phase and a soft magnetic phase can be confirmed from the shape of the M-H loop.

In the present invention, the term “hard magnetism” refers to a coercive force of equal to or higher than 240 kA/m, and the term “soft magnetism” refers to a coercive force of less than 8 kA/m.

The magnetic particle contained in the magnetic layer of the magnetic recording medium of the present invention will be described in greater detail below.

In the magnetic particle described above, a soft magnetic material is deposited on the surface of the hard magnetic particle. As set forth above, hard magnetic particles have high crystal magnetic anisotropy, and are thus thermally stable. The constant of crystal magnetic anisotropy of the hard magnetic particles is desirably equal to or greater than 1×10⁻¹ J/cc (1×10⁶ erg/cc), preferably equal to or greater than 6×10⁻¹ J/cc (6×10⁶ erg/cc). The higher the crystal magnetic anisotropy, the smaller the magnetic particles can be, which is advantageous in terms of electromagnetic characteristics such as the S/N ratio. When the constant of crystal magnetic anisotropy of the hard magnetic particles is equal to or greater than 1×10⁻¹ J/cc (1×10⁶ erg/cc), a coercive force that is suited to magnetic recording can be maintained when exchange interacted with the soft magnetic material to impart exchange coupling. When the constant of crystal magnetic anisotropy of the hard magnetic particles exceeds 6 J/cc (6×10⁷ erg/cc), the coercive force is high and recording properties may deteriorate even when exchange coupled with the soft magnetic phase. Thus, the constant of crystal magnetic anisotropy of the hard magnetic particles desirably does not exceed 6 J/cc (6×10⁷ erg/cc).

From the perspective of recording properties, the saturation magnetization of the hard magnetic particles is desirably 0.5×10⁻¹ to 2 A·m²/g (50 to 2,000 emu/g), preferably 5×10⁻¹ to 1.8 A·m²/g (500 to 1,800 emu/g). They can be of any shape, such as spherical or polyhedral. From the perspective of high-density recording, the size (diameter, plate diameter, etc.) of the hard magnetic particles is desirably 3 to 100 nm, preferably 5 to 10 nm. The “particle size” in the present invention can be measured by a transmission electron microscope (TEM). The average particle size in the present invention is defined as the average value of the particle sizes of 500 particles randomly extracted and measured in a photograph taken by a transmission electron microscope.

Examples of the hard magnetic particles are magnetic materials comprised of rare earth elements and transition metal elements; oxides of transition metals and alkaline earth metals; and magnetic materials comprised of rare earth elements, transition metal elements, and metalloids (also referred to as “rare earth-transition metal-metalloid magnetic materials” hereinafter). From the perspective of obtaining a suitable constant of crystal magnetic anisotropy set forth above, rare earth-transition metal-metalloid magnetic materials and hexagonal ferrite are desirable. Depending on the type of hard magnetic particle, there are times when oxides such as rare earth oxides will be present on the surface of the hard magnetic particle. Such hard magnetic particles are also included among the hard magnetic particles in the present invention.

More detailed descriptions of rare earth-transition metal-metalloid magnetic materials and hexagonal ferrite are given below.

### (Rare Earth-Transition Metal-Metalloid Magnetic Material)

Examples of rare earth elements are Y, Ce, Pr, Nd, Sm, Gd, Tb, Dy, Ho, Er, Tm, and Lu. Of these, Y, Ce, Pr, Nd, Gd, Tb, Dy, Ho, Pr, Nd, Tb, and Dy, which exhibit single-axis magnetic anisotropy, are preferred; Y, Ce, Gd, Ho, Nd, and Dy, which having constants of crystal magnetic anisotropy of 6×10⁻¹ J/cc to 6 J/cc (6×10⁶ erg/cc to 6×10⁷ erg/cc), are of greater preference; and Y, Ce, Gd, and Nd are of even greater preference.

The transition metals Fe, Ni, and Co are desirably employed to form ferromagnetic materials. When employed singly, Fe, which has the greatest crystal magnetic anisotropy and saturation magnetization, is desirably employed.

Examples of metalloids are boron, carbon, phosphorus, silicon, and aluminum. Of these, boron and aluminum are desirably employed, with boron being optimal. That is, magnetic materials comprised of rare earth elements, transition metal elements, and boron (referred to as “rare earth-transition metal-boron magnetic materials”, hereinafter) are desirably employed as the above hard magnetic phase. Rare earth-transition metal-metalloid magnetic materials including rare earth-transition metal-boron magnetic materials are advantageous from a cost perspective in that they do not contain expensive noble metals such as Pt, and can be suitably employed to fabricate magnetic recording media with good general-purpose properties.

The composition of the rare earth-transition metal-metalloid magnetic material is desirably 10 atomic percent to 15 atomic percent rare earth, 70 atomic percent to 85 atomic percent transition metal, and 5 atomic percent to 10 atomic percent metalloid.

When employing a combination of different transition metals as the transition metal, for example, the combination of Fe, Co, and Ni, denoted as Fe_{(1-x-y)} COₓNi_{y}, desirably has a composition in the ranges of x=0 atomic percent to 45 atomic percent and y=25 atomic percent to 30 atomic percent; or the ranges of x=45 atomic percent to 50 atomic percent and y=0 atomic percent to 25 atomic percent, from the perspective of ease of controlling the coercive force of the hard magnetic material to the range of 240 kA/m to 638 kA/m (3,000 Oe to 8,000 Oe).

From the perspective of low corrosion, the ranges of x=0 atomic percent to 45 atomic percent and y=25 atomic percent to 30 atomic percent, or the ranges of x=45 atomic percent to 50 atomic percent and y=10 atomic percent to 25 atomic percent, are desirable.

From the perspective of achieving good temperature characteristics with a Curie point of equal to or higher than 500° C., the ranges of x=20 atomic percent to 45 atomic percent and y=25 atomic percent to 30 atomic percent, or the ranges of x=45 atomic percent to 50 atomic percent and y=0 atomic percent to 25 atomic percent, are desirable.

Accordingly, from the perspectives of coercive force, corrosion, and temperature characteristics, the ranges of x=20 atomic percent to 45 atomic percent and y=25 atomic percent to 30 atomic percent or the ranges of x=45 atomic percent to 50 atomic percent and y=10 atomic percent to 25 atomic percent are desirable, and the ranges of x=30 atomic percent to 45 atomic percent and y=28 atomic percent to 30 atomic percent are preferred.

The above hard magnetic particles can be synthesized by a vapor phase method or a liquid phase method. However, high temperatures are required to synthesize a magnetic material of high crystal magnetic anisotropy. Thus, from the perspective of the heat resistance of the support, it is usually difficult to synthesize such a magnetic material on the nonmagnetic organic supports that are generally employed as supports in particulate magnetic recording media. Accordingly, the hard magnetic particles should be synthesized prior to being coated on a nonmagnetic organic support.

One method of obtaining a rare earth-transition metal-boron magnetic material comprises melting the starting material metals in a high-frequency melting furnace and then conducting casting. In this method, since a product containing a large amount of transition metal as primary crystals is obtained, it is necessary to conduct solution heat treatment directly below the melting point to eliminate the transition metal. Since the particle size increases in solution heat treatment, it is desirable to employ the synthesis method set forth further below to obtain a microparticulate magnetic material suited to high-density recording.

In the quenching method in which molten metal is poured onto rotating rolls (molten metal quenching method), Fe in the form of primary crystals is not produced, making it possible to obtain microparticulate (desirably, with a particle size of 3 nm to 200 nm) rare earth-transition metal-boron nanocrystals in a thin quenched band.

Further, forming an amorphous alloy by the quenching method of pouring molten metal onto rotating rolls, followed by the method of conducting a heat treatment at 400° C. to 1,000° C. in a nonoxidizing atmosphere (such as an inert gas, nitrogen, or a vacuum) to precipitate nanocrystals can yield microparticulate (desirably, with a particle size of 3 nm to 200 nm) rare earth-transition metal-boron nanocrystals.

When employing a molten metal quenching method on an alloy, it is desirable to employ an inert gas atmosphere to prevent oxidation. Specific examples of inert gases that are desirably employed are He, Ar, and N₂.

In the molten metal quenching method, the quenching rate is determined based on the rotational speed of the rolls and the thickness of the thin quenched band. In the present invention, the rotational speed of the rolls in the course of forming rare earth-transition metal-boron nanocrystals in the thin quenched band immediately following quenching is desirably 10 m/s to 25 m/s. The rotational speed of 25 m/s to 50 m/s is desirable to obtain an amorphous alloy once following quenching.

The thickness of the thin quenched band is desirably 10 μm to 100 μm. It is desirable to control the quantity of molten metal that is poured by means of the orifice or the like to permit a thickness within the above range.

Subsequently, microparticles can be obtained using the method of microparticulating the particles in the course of adsorbing and desorbing hydrogen (the HDDR method), or by gas flow dispersion or wet dispersion.

### (Hexagonal Ferrite)

Examples of hexagonal ferrite are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed; such hexagonal ferrite may be employed in the present invention. There are cases where a substitution element which substitutes for Fe is added as a coercive force-adjusting component for reducing a coercive force of hexagonal ferrite. However, incorporation of the substitution element reduces crystal magnetic anisotropy, and thus is not desirable from the perspective of thermal stability. To that end, hexagonal ferrite containing no substitution element is desirable for use as the hard magnetic particle. The hexagonal ferrite containing no substitution element has a composition denoted by general formula: AFe₁₂O₁₉ [wherein A is at least one element selected from the group consisting of Ba, Sr, Pb, and Ca].

The soft magnetic material that is deposited on the surface of the hard magnetic particle will be described next.

From the perspectives of exchange coupling with the hard magnetic particles and controlling the coercive force of the magnetic particles at a level that is suited to magnetic recording, the constant of crystal magnetic anisotropy of the soft magnetic material is desirably as low as possible, and the selection of a soft magnetic material with a negative value is acceptable. However, when a soft magnetic material having a negative constant of crystal magnetic anisotropy is exchange-coupled with hard magnetic particles, the magnetic energy of the magnetic particles ends up being low. Thus, the constant of crystal magnetic anisotropy of the soft magnetic material is desirably 0 to 5×10⁻² J/cc (0 to 5×10⁵ erg/cc), preferably 0 to 1×10⁻² J/cc (0 to 1×10⁵ erg/cc).

From the perspectives of exchange coupling with the hard magnetic particles and controlling the coercive force of the magnetic particles at a level that is suited to magnetic recording, the saturation magnetization of the soft magnetic material is desirably as high as possible. Specifically, it desirably falls within a range of 1×10⁻¹ to 2 A·m²/g (100 emu/g to 2,000 emu/g), preferably within a range of 3×10⁻¹ to 1.8 A·m²/g (300 to 1,800 emu/g).

Fe, an Fe alloy, or an Fe compound, such as iron, permalloy, sendust, or soft ferrite, is desirably employed as the soft magnetic material. The soft magnetic material can be selected from the group consisting of transition metals and compounds of transition metals and oxygen. Examples of transition metals are Fe, Co, and Ni. Fe and Co are desirable. When the hard magnetic particles are hexagonal ferrite, Co is preferred. This compound desirably comprises hydrogen in addition to a transition metal and oxygen, such as in CoHO₂, the presence of which is confirmed in Examples described further below. The soft magnetic material that is deposited on the hard magnetic particles can be a compound that does not contain an alkaline earth metal, such as is indicated in Examples set forth further below. The soft magnetic material can be present as an amorphous or crystalline substance on the surface of the hard magnetic particles. In this context, the term “amorphous substance” means that it is undetected as a diffraction peak in analysis by X-ray diffraction, and “crystalline substance” means that it is detected as a diffraction peak.

From the perspective of controlling the coercive force of the magnetic particles to a level suited to magnetic recording in the course of coupling, the exchange coupling energy between the hard magnetic particles and the soft magnetic material in the magnetic particles of the present invention is desirably adjusted to an optimal level based on the constant of crystal magnetic anisotropy of the hard magnetic particles. Specifically, the constant of crystal magnetic anisotropy of the soft magnetic material is desirably 0.01 to 0.3-fold that of the hard magnetic particles.

The exchange coupling energy can be adjusted by means of impurities at the interface, distortion, the crystalline structure, and the like.

The magnetic particle contained in the magnetic layer of the magnetic recording medium of the present invention comprises a hard magnetic particle and a soft magnetic material deposited on a surface of the hard magnetic particle in a state where the soft magnetic material is exchange-coupled with the hard magnetic particle. From the perspective of controlling the coercive force of the magnetic particle to a level suited to magnetic recording, the ratio accounted for by the soft magnetic material in the magnetic particle is desirably determined based on the coercive force of the hard magnetic particle. Taking into account the type of hard magnetic particle and the type of soft magnetic material that is deposited, the volumetric ratio of the hard magnetic particle to the soft magnetic material (hard magnetic particle/soft magnetic material) can be adjusted to achieve the desired coercive force. In one embodiment, it is, for example, 2/1 to 1/20, and can also be 1/1 to 1/15. In another embodiment, it is, for example, 500/1 to 1/20, and can also fall within a range of 200/1 to 1/20. When the hard magnetic particle is hexagonal ferrite, in the magnetic particle obtained by depositing a soft magnetic material on the hexagonal ferrite (hard magnetic particle) with exchange coupling of the soft magnetic material and the hexagonal ferrite, the ratio accounted for by the soft magnetic material is desirably less than 2 weight percent, preferably falling within a range of 0.1 to 1 weight percent. In the magnetic particle, the thickness of the soft magnetic material that is deposited on the hard magnetic particle is not specifically limited. However, it is desirably set to a suitable value to achieve the above volumetric ratio, for example, based on the volume of the hard magnetic particle. Further, the magnetic particle may have a core/shell structure in which a soft magnetic material constituting a deposition (shell) is present on the surface of a core in the form of a hard magnetic particle. That is, the magnetic particle can be a magnetic particle comprising a deposition of a soft magnetic phase on the surface of a hard magnetic phase, with the soft magnetic phase and the hard magnetic phase being exchange-coupled. However, in the magnetic particle contained in the magnetic layer of the magnetic recording medium of the present invention, a soft magnetic material may be deposited with exchange coupling to at least a portion of the surface of the hard magnetic particle; it is not necessary for the soft magnetic material to be coated over the entire surface of the hard magnetic particle. Accordingly, in the above magnetic particle, there may be portions where the hard magnetic particle is exposed and portions where the soft magnetic material is deposited.

The magnetic particle may comprise an oxide layer over the hard magnetic particle on which the soft magnetic material is deposited. The oxide layer can be formed by the usual slow oxidation treatment of the magnetic particle once the soft magnetic material has been deposited on the hard magnetic particle. The formation of an oxide layer as the outermost layer by slow oxidation treatment can increase the storage stability and enhances the handling properties of the magnetic particle.

However, there are times when it is desirable not to form the oxide layer from the perspective of magnetic characteristics. The portion that is oxidized by the slow oxidation treatment is mainly the outermost layer portion of the soft magnetic material. However, oxidation will sometimes compromise the magnetism of the outermost layer portion. By contrast, the formation of a carbon component on the surface of the magnetic particle as set forth further below is desirable from the perspective of increasing the storage stability and enhancing the handling properties through the presence of the carbon component.

The diameter of the magnetic particles is desirably 5 to 200 nm, preferably 5 to 25 nm. This is because microparticles are desirable in terms of electromagnetic properties such as the S/N ratio. However, when excessively small, the hard magnetic particle exhibits superparamagnetism and become unsuitable for recording. In a structure in which a soft magnetic material is deposited on the hard magnetic particle, the hard magnetic particle is smaller than the magnetic particle on which a deposition has been applied. This requirement is more stringent than for single particle. On the other hand, when the particle diameter exceeds 200 nm, particles that are suitable for recording and reproduction will be present among the magnetic particles in a single-component structure. Particles with diameters of equal to or less than 200 nm, at which size it is difficult to obtain single-component magnetic particle suited to recording and reproduction, are desirable.

The above magnetic particle can achieve a coercive force that is suited to recording by exchange coupling a hard magnetic particle with a soft magnetic material when the hard magnetic particle alone has a high thermal stability but also has a high coercive force that is unsuited to recording. That is, a coercive force that is suited to recording can be achieved because the spin of the hard magnetic particle will tend to change due to the effect of the spin in the exchange-coupled (interactively exchange coupled) soft magnetic material. Accordingly, excellent recording properties can be achieved in a magnetic recording medium containing a magnetic particle with high thermal stability in a magnetic layer. The coercive force of the above magnetic particle is lower than the coercive force of the hard magnetic particle because the soft magnetic material is exchange-coupled to the hard magnetic particle. It desirably falls within a range of equal to or higher than 80 kA/m but less than 240 kA/m. When the coercive force is excessively low, it becomes difficult to maintain recording due to the effect of adjacent recorded bits, and thermal stability deteriorates. When the coercive force is excessively high, recording becomes impossible. The coercive force is preferably equal to or higher than 160 kA/m but less than 240 kA/m. As set forth above, the coercive force of the hard magnetic material constituting the hard magnetic particle is equal to or higher than 240 kA/m and the coercive force of the soft magnetic material is less than 8 kA/m. The upper and lower limits are not specifically limited. The coercive force of generally available hard magnetic material is normally equal, to or less than 1,000 kA/m, and the coercive force of generally available soft magnetic material is normally equal to or higher than 0.04 kA/m.

The saturation magnetization can be increased relative to the hard magnetic particle alone by interactively exchange coupling the spin of the hard magnetic particle and the spin of the soft magnetic material as set forth above. Thus, a saturation magnetization falling within a range of 4.0×10⁻² to 2.2 A·m²/g (40 to 2,200 emu/g) can be achieved in the above magnetic particle. A saturation magnetization falling within this range is advantageous in terms of output. The saturation magnetization of the magnetic particle is preferably 5.4×10⁻² to 2.2 A·m²/g (54 to 2,200 emu/g), more preferably 1×10⁻¹ to 2.2 A·m²/g (100 to 2,200 emu/g), and still more preferably, falls within a range of 1.2×10⁻¹ to 1.8 A·m²/g (120 to 1,800 emu/g).

The method of manufacturing the above magnetic particle is not specifically limited. From the perspective of readily obtaining the magnetic particle of the above structure, a desirable manufacturing method comprises:

removing a solvent from a transition metal salt solution containing hard magnetic particles to form a deposition containing a transition metal salt on a surface of the hard magnetic particles (the “first step” hereinafter), and

forming a soft magnetic phase containing a transition metal on the surface of the hard magnetic particles by reductive decomposition of the transition metal salt in the deposition (the “second step” hereinafter).

The above manufacturing method will be described in greater detail below.

First Step

In the first step, the solvent is removed from a transition metal salt solution containing hard magnetic particles (also referred to as a “hard magnetic particle-containing salt solution” or, simply, “salt solution” hereinafter) to form a deposition containing a transition metal salt on the surface of the hard magnetic particles. The details of the hard magnetic particles are as set forth above.

The salt employed in the first step need only be the salt of a transition metal. To form a soft magnetic material following reductive decomposition, a salt of Fe, Co, or Ni is desirable, and a salt of Fe or Co is preferred. The salt may be organic or inorganic. Specifically, iron chloride, iron citrate, ferric ammonium citrate, iron sulfide, iron acetate, iron (III) acetylacetonate, ferric ammonium oxalate, cobalt chloride, cobalt citrate, cobalt sulfide, cobalt (III) acetylacetonate, nickel chloride, nickel sulfide, and the like can be employed. The salt may include transition metal complexes (complex salts). In the course of reductive decomposition, the salt is desirably an inorganic compound from the perspective of removing by-products.

The solvent of the above solution is not specifically limited other than that it be capable of dissolving the transition metal salt employed. Known solvents may be employed. However, solvents with high boiling points are undesirable from the perspective of facilitating removal of the solvent. In this regard, water, ketones (such as acetone), alcohols, and ethers are desirably employed. From the perspective of preventing oxidation in the course of immersion of the hard magnetic phase, the use of a solvent from which the oxygen has been removed by bubbling nitrogen or the like is desirable. In this process, volatization of the solvent employed can be prevented by using nitrogen gas that has been passed through the solvent in advance. It is also possible to use an oily solvent, but the use of a non-oily solvent is desirable from the perspective of facilitating removal of the solvent. In this regard, water, ketones, alcohols, and ethers are desirably employed.

The concentration of the salt in the salt solution is not specifically limited. However, when the salt concentration of the salt solution is excessively low, it becomes necessary to repeat the operation of immersing the hard magnetic particles in the salt solution, removing the solvent, precipitating the salt on the surface of the hard magnetic particles, and conducting reductive decomposition of the salt multiple times to form a soft magnetic phase of desired quantity on the surface of the hard magnetic particles. Further, an excessively high concentration is undesirable in that the particles end up clumping together in the course of immersing the hard magnetic particles in the salt solution, removing the solvent, and precipitating the salt on the surface of the hard magnetic particles. Taking the above factors into account, the salt concentration in the salt solution is desirably about 0.1 to 20 mmole per 100 g of solution.

From the perspective of uniformly adhering the salt to the surface of the particles, the quantity of magnetic particles in the salt solution is desirably about the quantity required to uniformly wet the surface of the hard magnetic particles. This is because when dry portions remain on the particle surface, adhesion of the salt becomes nonuniform, and when the salt solution is excessive, nonuniformities develop in the salt solution in the course of removing the solvent, resulting in nonuniformities in salt adhesion.

The method of preparing the salt solution is not specifically limited. It suffices to prepare it by simultaneously or successively admixing the hard magnetic particles and the transition metal salt with the solvent.

From the perspective of preventing oxidation of the hard magnetic particles, the atmosphere from the operation of immersing the hard magnetic particles in the solution up to the second step is desirably an inert atmosphere such as a nitrogen, argon, or helium atmosphere.

Following preparation of the salt solution containing the hard magnetic particles, the solvent is removed from the solution that has been prepared to cause the transition metal salt to precipitate out onto the surface of the hard magnetic particles. This permits the formation of a deposition containing the transition metal salt on the surface of the hard magnetic particles. Thermoprocessing, reduced pressure processing, or a combination of the two can be used to readily remove the solvent from the salt solution containing the hard magnetic particles. The heating temperature in thermoprocessing can be set based on the boiling point of the solvent. However, even when conducting processing in an inert atmosphere as set forth above, an excessively high temperature will sometimes result in oxidation of the hard magnetic particles by oxygen contained as an impurity in the atmosphere. From the perspective of preventing such oxidation, the heating temperature is desirably about 25 to 250° C., preferably about 25 to 150° C. In the course of removing the solvent by heating, the particles tend to aggregate. Thus, the use of a low temperature for a longer period is desirable to remove the solvent. In the removal of the solvent, suitable stirring of the salt solution can promote uniform precipitation of the transition metal salt on the surface of the hard magnetic particles. Further, to prevent oxidation and prevent aggregation of particles, it is desirable to remove the solvent by processing under reduced pressure. The reduced pressure processing can be conducted at a reduced pressure of 0.1 to 8,000 Pa with an aspirator or rotary pump. In this process, the solvent that is removed is desirably removed with a cold trap. Since the heat of vaporization accompanying volatization of the solvent during reduced pressure processing will cause the temperature of the sample to drop, reducing the efficiency of solvent removal, heating to 25 to 50° C. is desirable.

In the first step, the above operations can form a deposition containing the transition metal salt on the surface of the hard magnetic particles. The thickness of the deposition can be suitably adjusted by means of, for example, the salt concentration in the salt solution so as to permit the formation of the desired quantity of soft magnetic phase on the surface of the hard magnetic particles. The deposition formed in this step does not have to cover the entire surface of the hard magnetic particle. It is permissible for portions where the surface of the hard magnetic particle is exposed and portions where other substances are deposited to remain.

Second Step

In the second step, the transition metal salt in the deposition that was formed in the first step is subjected to reductive decomposition to form a soft magnetic phase containing a transition metal on the surface of the hard magnetic particles. The reductive decomposition is desirably conducted by heating hard magnetic particles on which the deposition has been formed in a reducing atmosphere. A reducing gas in the form of hydrogen, carbon monoxide, or a hydrocarbon can be employed. Hydrogen and carbon monoxide are desirable in that they oxidize during reductive decomposition, and are eliminated from the particles as gas in the form of water and carbon dioxide. From the perspective of the reaction efficiency of the reductive decomposition, the atmospheric gas during reductive decomposition is desirably one that contains equal to or more than 50 volume percent, preferably equal to or more than 90 volume percent, of a reducing gas. Providing a gas inlet and gas outlet in the reaction vessel and discharging the gas following the reaction while constantly introducing a reducing gas flow during reductive decomposition is preferred from the perspective of reaction efficiency. Conducting reductive decomposition in a reducing gas flow is advantageous in that Ca impurities are not introduced through Ca reduction or the like and by-products of reductive decomposition are carried away in the gas phase. In view of safety, hydrogen that has been diluted with an inert gas is also desirably employed. However, in such cases, reductive decomposition take a long time.

There are also cases in which it is desirable to conduct the reduction reaction in a moderate manner from the perspective of equipment. Reduction processing can be conducted in an atmosphere with relatively low reducing strength to proceed with the reduction reaction in a moderate fashion. Such reduction processing takes a long time for reductive decomposition, but it is desirable in that attention for safety is not required. Since hard magnetic particles that are oxides (such as hexagonal ferrite) readily reduce, the use of a reducing gas of great reducing strength will sometimes reduce and decompose the entire hard magnetic particle even after a deposition has been formed on its surface. Thus, the reduction reaction is desirably conducted in a moderate fashion. In that case, it is desirable to employ a reducing gas of relatively low reducing strength. Alternatively, the concentration of the reducing gas in the atmospheric gas during reductive decomposition can be suitably reduced, for example, up to about 5 volume percent.

Hydrocarbons are reducing gases that have relatively low reducing strength and thus are desirable when conducting the reduction reaction in a moderate fashion as set forth above. The hydrocarbon is not specifically limited, and may be saturated or unsaturated. Specific examples are methane, ethane, propane, butane, and other saturated hydrocarbons, and ethylene, acetylene, and other unsaturated hydrocarbons. From the perspective of facilitating handling, methane and ethane are desirable, with the use of methane being preferable. The use of a hydrocarbon that has been diluted with an inert gas such as nitrogen is desirable to adjust the reducing strength. This embodiment is also desirable from the perspective of safety because the gases employed are in the form of incombustible gases. It is presumed that when a hydrocarbon is employed as the reducing gas, oxidation of the hydrocarbon accompanying reduction produces carbon and/or carbide (collectively referred to as “carbon components” in the present invention) on the surface of the deposition. As indicated in Examples described further below, the presence of a carbon component (graphite) was determined on the outermost surface of the magnetic particles following reductive decomposition (that is, the outermost layer of the magnetic particles having a structure consisting of a soft magnetic material deposited on the surface of hard magnetic particles). Accordingly, one embodiment of the present invention provides a magnetic particle in which a carbon component is present on a hard magnetic particle that has been deposited with a soft magnetic material. The reason why it is desirable to use a hydrocarbon as the reducing gas when faced with the need to conduct a moderate reduction reaction is presumed that the carbon component can play a role of inhibiting excessive reduction. On the other hand, as set forth further below, the presence of carbon component is sometimes undesirable in a magnetic layer. In that case, a reducing gas which produces no carbon component as a by-product in the reduction reaction is desirably employed. In this regard, hydrogen is a desirable reducing gas. Since hydrogen is a reducing gas of great reducing strength, it is desirable to use hydrogen diluted with an inert gas in a concentration of equal to or less than 5 volume percent, for example, 1 to 5 volume percent, to conduct the reduction reaction in a moderate fashion.

A heating temperature in the atmosphere containing a reducing gas that is excessively low is undesirable when conducting reductive decomposition in the atmosphere containing a reducing gas because a long time is required for reductive decomposition and operating efficiency is poor. A heating temperature that is excessively high would be dangerous if the reducing gas were to leak. From these perspectives, in the atmosphere containing a reducing gas, particularly in reductive decomposition in a hydrogen gas flow, the heating temperature desirably falls within a range of 300 to 550° C. The discharged gas can be processed with a scrubber to remove by-products in the course of the reductive decomposition of a transition metal salt.

The above step makes it possible to reduce the transition metal salt in the deposition on the surface of the hard magnetic particle to a transition metal. This permits the formation of a soft magnetic phase containing a transition metal on the surface of the hard magnetic particle. The soft magnetic material and hard magnetic particle are present in an exchange-coupled state within the magnetic particle thus formed. The fact that the soft magnetic material and hard magnetic particle are exchange-coupled in the magnetic particle that has been formed can be confirmed by the methods set forth above. Using the above-described solvent, for example, to clean away any unreacted portions of transition metal salt employed as starting material to form the soft magnetic phase that may be present following reductive decomposition in the soft magnetic phase of the magnetic particle is desirable from the perspective of magnetic characteristics.

Oxidation treatment (slow oxidation treatment) of the magnetic particles following reductive decomposition is desirable to form an oxide layer on the outermost layer. That is because the particles tend to catch fire following reduction processing, should be handled in an inert gas, and are difficult to handle. Oxidation processing can be conducted by a known slow oxidation treatment. However, as set forth above, magnetic particles in which a carbon component is present can afford good handling properties without the formation of an oxide layer.

The magnetic particle comprising a hard magnetic particle and a soft magnetic material deposited on a surface of the hard magnetic particle in a state where the soft magnetic material is exchange-coupled with the hard magnetic particle can be obtained by the manufacturing method set forth above. However, the magnetic particle contained in the magnetic layer of the magnetic recording medium of the present invention is not limited to the magnetic particle obtained by the above manufacturing method, and need only be the magnetic particle in which a soft magnetic material is deposited in an exchange-coupled form on the surface of hard magnetic particle.

One characteristic that is desirable in a magnetic recording medium for high-density recording is the presence of a magnetic layer of high surface smoothness. Thus, it is desirable to inhibit the aggregation of ferromagnetic powder. To inhibit the aggregation of ferromagnetic powder, it is effective to fill the area around the magnetic particles with binder to prevent the particles from coming together (aggregating). To that end, it is important to increase the compatibility of the magnetic particle surface with the binder. The present inventors conducted extensive research in this regard. As a result, they discovered an additive component for modifying the surface of the magnetic particles and enhancing compatibility with the binder in the form of an aromatic compound in which a substituent selected from the group consisting of a hydroxyl group and a carboxyl group is directly substituted onto the aromatic ring (also referred to as a “surface modifier” hereinafter). The binders that are employed in the magnetic layer are generally highly hydrophobic. By contrast, the surface of the magnetic particles is highly hydrophilic. Accordingly, in that state, the magnetic particles have poor compatibility with the binder. However, in the above surface modifier, the substituent can adsorb to the surface of the magnetic particles. It is thought to render the surface of the magnetic particles hydrophobic by means of the aromatic ring, and thus surround the surface of the magnetic particles with binder and inhibit decreased dispersion (aggregation) due to particles coming together. Accordingly, the magnetic recording medium of the present invention desirably contains the above surface modifier in the magnetic layer thereof.

The surface modifier will be described in greater detail below.

The aromatic ring having the above substituent that is present in the surface modifier can have a monocyclic or polycyclic structure, and can be a carbon ring or a hetero ring. When the structure is polycyclic, it can be a condensed ring or a ring assembly in which two or more rings are linked through single bonds. Specific examples of the aromatic ring are naphthalene rings, biphenyl rings, anthracene rings, pyrene rings, and phenanthrene rings. Desirable examples of aromatic rings are naphthalene rings, biphenyl rings, anthracene rings, and pyrene rings. Preferred examples of aromatic rings are naphthalene rings and biphenyl rings.

In the surface modifier, a substituent selected from the group consisting of a hydroxyl group and a carboxyl group is directly substituted onto the above-described aromatic ring. The presence of a substituent selected from the group consisting of a hydroxyl group and a carboxyl group can result in suitable adsorption to the magnetic particle and inhibit aggregation. The number of substituents selected from the group consisting of a hydroxyl group and a carboxyl group that are contained in the compound can be one or more, two or more, or three or more. To achieve suitable adsorption strength, one or two are desirable.

The aromatic ring may contain substituents in addition to the substituent selected from the group consisting of a hydroxyl group and a carboxyl group. These substituents are not specifically limited. Examples are halogen atoms (such as fluorine atoms, chlorine atoms, bromine atoms, and iodine atoms) and alkyl groups. However, an excessively high strength of adsorption of the surface modifier to the magnetic particles is undesirable in that it sometimes promotes coming together of the magnetic particles. From this perspective, the presence of substituents exhibiting greater strength of adsorption to the surface of the magnetic particles than hydroxyl groups and carboxyl groups (such as sulfonic acid groups and salts thereof) is undesirable. Nor is the presence of substituents that exert a major effect on the hydrophilic or hydrophobic property of the compound desirable. From these perspectives, the surface modifier desirably does not contain substituents in addition to the substituent selected from the group consisting of a hydroxyl group and a carboxyl group.

The surface modifier is desirably not a polymer compound such as those employed as binders. That is because the more additive components used in the magnetic layer, the lower the fill rate of the magnetic material, which is undesirable from the perspective of increasing the recording density. In the case of a polymer compound, a large quantity is added to achieve a high degree of dispersion. To achieve a good dispersion-enhancing effect by adding a small quantity, the surface modifier desirably contains one aromatic ring per molecule. In this context, a ring assembly of two or more rings linked together by a single bond is counted as a single aromatic ring, and the aromatic rings contained in two or more rings that are linked through a linking group other than a single bond are counted as multiple rings. For similar reasons, the surface modifier desirably has a molecular weight of equal to or lower than 1,000, preferably equal to or lower than 500, and more preferably, equal to or lower than 200. The lower limit of the molecular weight of the surface modifier is not specifically limited, but when taking into account the molecular weight of the substituent and aromatic ring contained in the structure, a lower limit of, for example, equal to or higher than 100, or equal to or higher than 150, can be adopted.

The above-described surface modifier is desirably naphthalene onto which the substituent directly substitutes or biphenyl onto which the substituent directly substitutes, preferably dihydroxynaphthalene or biphenylcarboxylic acid, and more preferably, dihydroxynaphthalene.

From the perspective of enhancing dispersion in the magnetic recording medium of the present invention, the surface modifier is desirably incorporated into the magnetic layer in a quantity of equal to or more than 1.5 weight parts per 100 weight parts of ferromagnetic powder. Since increasing the fill rate of the ferromagnetic powder is desirable from the perspective of achieving higher density recording as set forth above, it is desirable to decrease the quantity of additives added to the extent that their effects are still achieved. From this perspective, the content of the surface modifier in the magnetic layer is desirably equal to or less than 10 weight parts per 100 weight parts of ferromagnetic powder. From the perspective of achieving both a high fill rate and dispersion of the ferromagnetic powder, the content of the surface modifier in the magnetic layer is preferably 3 to 10 weight parts per 100 weight parts of ferromagnetic powder.

Research conducted by the present inventors has revealed that not using the surface modifier in combination with carbon black, which is widely employed as a magnetic layer component in particulate magnetic recording media, is desirable in terms of achieving a better dispersion-enhancing effect. The present inventors surmise that this is because the surface modifier tends to bond with carbon black, and the carbon black ends up associating with the magnetic particles through the surface modifier, forming large aggregation products. However, since carbon black is a component that forms protrusions on the surface of the magnetic layer and reduces the coefficient of friction, simply eliminating the carbon black as a magnetic layer component, even though it increases dispersion of the ferromagnetic powder (and thus increases surface smoothness), ends up decreasing running durability by increasing the coefficient of friction during running Accordingly, to simultaneously improve both dispersion and running durability, it is desirable to employ a component which lowers a coefficient of friction (also referred to as a “coefficient of friction-lowering component”, hereinafter) other than carbon black. An example of such a coefficient of friction-lowering component is a nonmagnetic inorganic particle. That is, to achieve both enhanced dispersion and running durability, it is desirable to incorporate nonmagnetic inorganic particles as a coefficient of friction-lowering component together with the surface modifier in the magnetic recording medium of the present invention. In the present invention, the “coefficient of friction-lowering component” refers to a component that forms suitable protrusions on the surface of the magnetic layer to exhibit an effect of lowering the coefficient of friction generated in the course of contact between the magnetic recording medium and the head during the recording or reproduction of a magnetic signal relative to when this component is not contained. Nor is carbon black contained in the nonmagnetic inorganic particles in the present invention. To achieve a better dispersion-enhancing effect based on the surface modifier, it is desirable not to incorporate carbon black in the magnetic layer in the magnetic recording medium of the present invention. In this context, the phrase “not incorporate carbon black” or “comprise no carbon black” means no active addition of carbon black as a magnetic layer component. For example, in the process of manufacturing a magnetic recording medium, the unintentional mixing into the magnetic layer of carbon black contained as a component of another layer (such as nonmagnetic layer carbon black) is permissible.

Examples of inorganic materials constituting the nonmagnetic inorganic particles are: metal oxides, metal carbonates, metal sulfates, metal nitrides, metal carbides, and metal sulfides. Specifically, one or a combination of two or more from among α-alumina with an α-conversion rate of equal to or greater than 90 percent, β-alumina, γ-alumina, θ-alumina, silicon dioxide, silicon carbide, chromium oxide, cerium oxide, α-iron oxide, goethite, corundum, silicon nitride, titanium carbide, titanium dioxide, tin oxide, magnesium oxide, tungsten oxide, zirconium oxide, boron nitride, zinc oxide, calcium carbonate, calcium sulfate, barium sulfate, and molybdenum disulfide can be employed. From the perspective of the availability of particles of good size distribution and dispersion, inorganic oxides are desirable and silica (silicon dioxide) is preferred.

From the perspective of dispersion, nonmagnetic inorganic particles in the form of colloidal particles are desirably employed. From the perspective of availability, colloidal particles in the form of inorganic oxide colloidal particles are preferred. Examples of inorganic oxide colloidal particles are colloidal particles of the above inorganic oxides. Specific examples are compound inorganic oxide colloidal particles of SiO₂.Al₂O₃, SiO₂.B₂O₃, TiO₂.CeO₂, SnO₂.Sb₂O₃, SiO₂.Al₂O₃.TiO₂, and TiO₂.CeO₂.SiO₂. Desirable examples are inorganic oxide colloidal particles of SiO₂, Al₂O₃, TiO₂, ZrO₂, and Fe₂O₃. From the perspective of the availability of monodispersions of colloidal particles, silica colloidal particles (colloidal silica) are preferred.

Since the surface of colloidal particles is generally hydrophilic, they are suited to the preparation of colloidal solutions with water as the dispersion medium. For example, the surface of colloidal silica obtained by the usual synthesis methods is covered by polarized oxygen atoms (O²⁻). Thus, it can adsorb water to form hydroxyl groups in water, becoming stable. However, in the organic solvents that are employed in coating liquids for use in magnetic recording media, these particles tend not to remain unchanged in a colloidal state. Accordingly, to permit the dispersion in a colloidal state of these particles in organic solvents, the particle surface can be treated to render it hydrophobic. In the present invention, as well, it is desirable to employ colloidal particles that have been rendered hydrophobic in this manner. The details of such hydrophobic treatments are described, for example, in Japanese Unexamined Patent Publication (KOKAI) Heisei Nos. 5-269365 and 5-287213, and Japanese Unexamined Patent Publication (KOKAI) No. 2007-63117. The contents of the above publications are expressly incorporated herein by reference in their entirety. Colloidal particles that have been surface treated in this manner can be synthesized by the methods described in the above-cited publications, for example, or obtained as commercial products.

From the perspective of forming suitable protrusions for contributing to reduction in the coefficient of friction on the surface of the magnetic layer, the average particle size of the nonmagnetic inorganic particles is desirably greater than or equal to, preferably 1.2-fold or more, the thickness of the magnetic layer. From the perspective of preventing spacing loss due to excessive protrusion by the nonmagnetic inorganic particles, they are desirably two-fold or less, preferably 1.7-fold or less, the thickness of the magnetic layer. To achieve even better electromagnetic characteristics, the average particle size of the nonmagnetic inorganic particles desirably falls within a range of 50 to 200 nm. The thickness of the magnetic layer is desirably optimized based on the saturation magnetization level and head gap length of the magnetic head employed, and the band of the recording signal. From the perspective of further enhancing electromagnetic characteristics, the thickness of the magnetic layer is desirably equal to or less than 200 nm, preferably equal to or less than 170 nm, and more preferably, equal to or less than 80 nm. From the perspective of obtaining a uniform magnetic layer, the thickness of the magnetic layer is desirably equal to or more than 10 nm, preferably equal to or more than 30 nm, and more preferably, equal to or more than 50 nm.

The average particle size of the nonmagnetic inorganic particles is a value that is measured by the following method.

An image of the nonmagnetic inorganic particles is printed out on print paper with a transmission electron microscope to obtain a particle photograph. For example, a model H-9000 transmission electron microscope made by Hitachi can be used to pick up the image of particles at a magnification of about 50,000 to 100,000-fold and print it on print paper to obtain a particle photograph.

Next, 50 particles are randomly extracted from the particle photograph, the contours of each particle are traced with a digitizer, and the diameter of a circle of identical area to each of the traced regions (circle equivalent diameter) is calculated. In the present invention, the term “nonmagnetic inorganic particle size” is the diameter thus calculated. To calculate the particle size, for example, a Carl Zeiss KS-400 image analysis software package can be employed. Scale correction in scanner image pickup and image analysis can be conducted with a circle 1 cm in diameter, for example.

The arithmetic average value calculated for the diameters of the 50 particles measured by the above method is adopted as the average particle size of the nonmagnetic inorganic particles. The average particle size of the granular materials contained in the magnetic layer, described further below, is a value that is similarly measured and calculated.

The average particle size that is obtained by the above method is an average value calculated for 50 primarily particles. The term “primary particle” means an independent grain of powder that is unaggregated. Accordingly, the sample particles for measuring the average particle size of the nonmagnetic inorganic particles can be either sample powder collected from the magnetic layer or starting material powder so long as measurement of the size of primary particles is possible. Reference can be made to paragraph [0015] of Japanese Unexamined Patent Publication (KOKAI) No. 2011-48878, which is expressly incorporated herein by reference in its entirety, with regard to methods of collecting sample powder from the magnetic layer.

The content of nonmagnetic inorganic particles in the magnetic layer is desirably set to within a range permitting good electromagnetic characteristics and a low coefficient of friction. Specifically, it is desirably set to 0.5 to 5 weight parts, preferably 1 to 3 weight parts, per 100 weight parts of ferromagnetic powder.

Additives can be added as needed to the magnetic layer, and to any nonmagnetic layer optionally provided in the magnetic recording medium of the present invention. Examples of additives are abrasives, lubricants, dispersing agents, dispersion adjuvants, antimicrobial agents, antistatic agents, oxidation inhibitors, and solvents. For details regarding specific examples of these additives, reference can be made to paragraphs [0075] to [0083] in Japanese Unexamined Patent Publication (KOKAI) No. 2006-108282, which is expressly incorporated herein by reference in its entirety. Use of the additives employed in the magnetic layer and nonmagnetic layer in the present invention can differ as needed based on quantity and type. All or part of the additives employed in the present invention can be added in any step during manufacturing of the coating liquid for the magnetic layer or nonmagnetic layer. For example, there are cases in which they are admixed with the ferromagnetic powder prior to the kneading step, cases in which they are added during the kneading step along with the ferromagnetic powder, binder, and solvent, cases in which they are added during the dispersing step, cases in which they are added after dispersion, and cases in which they are added immediately before coating.

In the present invention, granular substances comprised of different materials from the above nonmagnetic inorganic particles are desirably incorporated as additives into the magnetic layer. The inorganic powders that are commonly added as abrasives can be employed as such granular substances. In the present invention, the term an “abrasive contained in the magnetic layer” means a granular substance of a higher degree of Mohs hardness than the nonmagnetic inorganic particles contained as a coefficient of friction-lowering component in the same layer. For example, since the Mohs hardness of silica particles is 7, a granular substance with a Mohs hardness of equal to or higher than 8 corresponds to an abrasive in a magnetic layer containing silica particles as nonmagnetic inorganic particles. Incorporating an abrasive into the magnetic layer can increase the abrasiveness of the magnetic layer and permit the elimination of material adhering to the head. From the perspective of enhancing the abrasiveness of the magnetic layer, an abrasive in the form of an inorganic powder having a Mohs hardness of equal to or higher than 8 is desirably employed, and an inorganic powder having a Mohs hardness of equal to or higher than 9 is preferably employed. The highest Mohs hardness value is that of diamond, at 10. Specific examples are alumina (Al₂O₃), silicon carbide, boron carbide (B₄C), TiC, cerium oxide, zirconium oxide (ZrO₂), and diamond powder. Of these, alumina, silicon carbide, and diamond are desirable. These inorganic powders may be of any shape, such as acicular, spherical, or cubic, and desirably have an angularly shaped portion to enhance abrasiveness. The formation of protrusions on the surface of the magnetic layer with inorganic powder employed as abrasive in this manner to lower the coefficient of friction is also conceivable. However, when forming protrusions on the surface of the magnetic layer in a quantity capable of maintaining the running durability with abrasives alone, the abrading ability becomes excessively high and head damage becomes pronounced. Additionally, it is difficult to lower the coefficient of friction by forming protrusions with abrasives within a range that does not greatly damage the head. Accordingly, in the present invention, it is desirable to employ nonmagnetic inorganic particles and abrasives in combination. From the perspective of not imparting substantial damage to the head with an abrasive, the average particle diameter of the abrasive is desirably 10 to 300 nm, preferably 30 to 250 nm, and more preferably, 50 to 200 nm. The quantity added is desirably 1 to 20 weight parts, preferably 2 to 15 weight parts, and more preferably 3 to 10 weight parts per 100 weight parts of ferromagnetic powder.

The magnetic recording medium of the present invention is a particulate magnetic recording medium having a magnetic layer containing the above-described magnetic particles and a binder on a nonmagnetic support. The magnetic recording medium of the present invention can be a magnetic recording medium with a laminate structure sequentially comprising, on a nonmagnetic support, a nonmagnetic layer containing a nonmagnetic powder and a binder and the above magnetic layer, or a magnetic recording medium having a backcoat layer on the opposite surface of the nonmagnetic support from the surface on which the magnetic layer is present. When the above surface modifier is employed as a component of the magnetic layer in the magnetic recording medium of the present invention, it is desirable to exclude carbon black as a component of the magnetic layer to adequately enhance dispersion of the ferromagnetic powder by the surface modifier. However, even in such cases, carbon black can be added to the nonmagnetic layer to lower the surface electric resistance and the like.

The thickness structure of the magnetic recording medium of the present invention is as follows. The thickness of the nonmagnetic support is, for example, 3 to 80 μm, desirably 3 to 50 μm, and preferably 3 to 10 μm. The thickness of the magnetic layer is as set forth above. The thickness of the nonmagnetic layer is, for example. 0.1 to 3.0 μm, desirably 0.3 to 2.0 μm, and more preferably, 0.5 to 1.5 μm. So long as the nonmagnetic layer is essentially nonmagnetic and produces its effect, it can be viewed as exhibiting the effect of the present invention and having essentially the same structure as the magnetic recording medium of the present invention even when it contains trace amounts of magnetic material, either as impurities or as intended components. “Essentially the same” means that the residual magnetic flux density of the nonmagnetic layer is equal to or lower than 10 mT or the coercive force is equal to or lower than 7.96 kA/m (100 Oe); desirably, there is no residual magnetic flux density or coercive force. The thickness of the backcoat layer is desirably equal to or less than 0.9 μm, preferably 0.1 to 0.7 μm.

Known techniques relating to magnetic recording media can be applied for the remaining details of the magnetic recording medium of the present invention. For example, reference can be made to paragraphs [0024] to [0039] and [0068] to [0116] of, and to the description of Examples in, Japanese Unexamined Patent Publication (KOKAI) No. 2007-294084, which is expressly incorporated herein by reference in its entirety, for details regarding the materials and components constituting magnetic recording media and for methods of manufacturing magnetic recording media. In particular, to obtain a magnetic recording medium in which the above magnetic particles are dispersed to a high degree and which affords good electromagnetic characteristics, the techniques described in paragraphs [0024] to [0029] in Japanese Unexamined Patent Publication (KOKAI) No. 2007-294084 are desirably applied. The nonmagnetic layer and magnetic layer can be formed by simultaneously multilayer coating (wet-on-wet) in which the magnetic layer coating liquid is applied while the nonmagnetic layer coating liquid is still wet, or by sequential multilayer coating (wet-on-dry) in which the magnetic layer coating liquid is applied after the nonmagnetic layer coating liquid has dried. To form a quantity of protrusions on the surface of the magnetic layer that effectively lowers the coefficient of friction, it is desirable for the quantities of nonmagnetic inorganic particles and abrasive components in the magnetic layer that sink into the nonmagnetic layer to be small. From this perspective, it is desirable to conduct sequential multilayer coating. Reference can also be made to paragraphs [0057] to [0067] of Japanese Unexamined Patent Publication (KOKAI) No. 2006-108282 for details relating to the method of manufacturing the magnetic recording medium.

### EXAMPLES

The present invention will be described in detail below based on Examples. However, the present invention is not limited to the examples.

### Reference Examples 1 to 8

### Preparation Examples Employing Nd₂Fe₁₄B as the Hard Magnetic Phase

Magnetic powder comprised of gathering hard magnetic particles of Nd₂Fe₁₄B composition that had been prepared by HDDR method (Hc: 734 kA/m, saturation magnetization: 1.42×10⁻¹ A·m²/g (142 emu/g), average crystal particle diameter: 100 nm) was immersed in the salt solution (0.5 g of solution per gram of magnetic powder) indicated in Table 1 in such a manner as to wet the surface of the particles, and heated to 110° C. in a nitrogen atmosphere to remove the solvent. In this process, the particles in the salt solution were stirred once every 30 minutes.

The dry powder obtained by removing the solvent was processed for one hour at 400° C. in a hydrogen gas flow to subject to reductive decomposition the Fe salt contained in the deposition on the surface of the particles. During reductive decomposition, the hydrogen gas that was discharged contained by-products during the course of salt decomposition, and was thus processed with a scrubber. Subsequently, the temperature was lowered to room temperature, the atmosphere in the reaction vessel was replaced with a nitrogen atmosphere, and the powder was removed.

Subsequently, the magnetic powders of Reference Examples 3 and 6 in Table 1 were heated to 70° C. in a nitrogen atmosphere. While maintaining a temperature of 70° C., the nitrogen was mixed with air to gradually increase the concentration of oxygen to 0.35 volume percent and a surface oxidation treatment (slow oxidation treatment) was conducted.

The above step yielded a magnetic powder comprised of gathering core/shell magnetic particles in which the core was comprised of ND₂Fe₁₄B hard magnetic phase and the shell was comprised of Fe-containing soft magnetic phase.

### Reference Comparative Example 1

Magnetic powder comprised of gathering hard magnetic particles of Nd₂Fe₁₄B composition that had been prepared by HDDR method (Hc: 734 kA/m, saturation magnetization: 1.42×10⁻¹ A·m²/g (142 emu/g), and average crystal particle diameter: 100 nm) was employed as is as the magnetic powder in Reference Comparative Example 1.

### Evaluation of Magnetic Powders

(1) Evaluation of Magnetic Characteristics

The magnetic characteristics of the magnetic powders comprised of core/shell magnetic particles obtained in Reference Examples 1 to 8 and the magnetic powder of Reference Comparative Example 1 were evaluated under conditions of an applied magnetic field of 3,184 kA/m (40 kOe) with a superconducting vibrating sample magnetometer (VSM) made by Tamagawa Co. To prevent fast oxidation, the various magnetic powders were sealed in acrylic containers in nitrogen atmospheres for evaluation.

(2) Composition Evaluation

The Fe/Nd ratio (atomic ratio) of the magnetic particles constituting the various magnetic powders was measured with a model HD2300 STEM (200 kV) made by Hitachi.

(3) Handling Property (Rise in Temperature in Air)

The various magnetic powders were charged to an alumina crucible in a draft and a determination was made as to whether or not the temperature rose when placed in air.

TABLE 1

| | | Quantity | | | | |
|---|---|---|---|---|---|---|
| | | of salt | | | | |
| | | per 100 g of | Coercive | | | Rise in |
| | | solution | Force | Saturation | Composition | temperature |
| Sample | Salt/solvent | (mmol) | (kA/m) | magnetization | Fe/Nd | in air |
| Ref. | Iron (II) | 3.5 | 200 | 1.52 × 10⁻¹ A · m²/g | 6.5 | Observed |
| Ex. 1 | chloride | | | (152 emu/g) | | |
| | tetrahydrate/ | | | | | |
| | water | | | | | |
| Ref. | Iron (II) | 5.25 | 120 | 1.52 × 10⁻¹ A · m²/g | 6.8 | Observed |
| Ex. 2 | chloride | | | (152 emu/g) | | |
| | tetrahydrate/ | | | | | |
| | water | | | | | |
| Ref. | Iron (II) | 5.25 | 110 | 1.44 × 10⁻¹ A · m²/g | 6.8 | None |
| Ex. 3 | chloride | | | (144 emu/g) | | |
| | tetrahydrate/ | | | | | |
| | water | | | | | |
| Ref. | Ferric | 3.5 | 190 | 1.52 × 10⁻¹ A · m²/g | 6.3 | Observed |
| Ex. 4 | ammonium | | | (152 emu/g) | | |
| | citrate/water | | | | | |
| Ref. | Ferric | 5.25 | 110 | 1.51 × 10⁻¹ A · m²/g | 6.5 | Observed |
| Ex. 5 | ammonium | | | (151 emu/g) | | |
| | citrate/water | | | | | |
| Ref. | Ferric | 5.25 | 105 | 1.44 × 10⁻¹ A · m²/g | 6.5 | None |
| Ex. 6 | ammonium | | | (144 emu/g) | | |
| | citrate/water | | | | | |
| Ref. | Iron (II) | 35 | 40 | 1.52 × 10⁻¹ A · m²/g | 8.2 | Observed |
| Ex. 7 | chloride | | | (152 emu/g) | | |
| | tetrahydrate/ | | | | | |
| | water | | | | | |
| Ref. | Ferric | 35 | 35 | 1.51 × 10⁻¹ A · m²/g | 8.3 | Observed |
| Ex. 8 | ammonium | | | (151 emu/g) | | |
| | citrate/water | | | | | |
| Ref. | None | None | 734 | 1.42 × 10⁻¹ A · m²/g | 6.0 | Observed |
| Comp. | | | | (142 emu/g) | | |
| Ex. 1 | | | | | | |

### Evaluation Results

In Table 1, the composition of Reference Comparative Example 1 is the Fe/Nd composition ratio of magnetic particles without a soft magnetic phase, that is, the Fe/Nd composition of hard magnetic particles with a composition of Nd₂Fe₁₄B. The values of the Fe/Nd composition ratios of Reference Examples 1 to 8 were higher than the value of Reference Comparative Example 1. Thus, in Reference Examples 1 to 8, Fe was determined to be present in a soft magnetic phase on the surface of the hard magnetic particles.

The coercive force of the magnetic powders of Reference Examples 1 to 8 was lower than the coercive force of the magnetic powder of Reference Comparative Example 1. Thus, a soft magnetic phase exchange-coupled to a hard magnetic phase was determined to be present on the surface of the hard magnetic particles (hard magnetic phase) in the magnetic powders of Reference Examples 1 to 8. Due to high crystal magnetic anisotropy, the hard magnetic phase had good thermal stability. However, the coercive force was high and thus a large external magnetic field was required for recording, rendering recording difficult. By contrast, decrease in the coercive force of the magnetic particle can be achieved by exchange coupling the core and shell in a core/shell structure with a core in the form of a hard magnetic phase and a shell in the form of a soft magnetic phase as set forth above. In particular, a coercive force within a range of equal to or higher than 80 kA/m but less than 240 kA/m, suitable to recording, can be achieved in Reference Examples 1 to 6. Thus, the recording properties of hard magnetic particles with good thermal stability can be improved in the magnetic particles comprising a hard magnetic particle and a soft magnetic material deposited on a surface of the hard magnetic particle in a state where the soft magnetic material is exchange-coupled with the hard magnetic particle.

Further, the saturation magnetization of each of the magnetic powders of Reference Examples 1 to 8 was higher than the saturation magnetization of the magnetic powder of Reference Comparative Example 1. Thus, exchange coupling of the soft magnetic phase to the hard magnetic phase was confirmed to increase the saturation magnetization.

From the results in Table 1, it was found that the salt concentration could be used to control the quantity of soft magnetic phase on the hard magnetic particles, that this permitted the adjustment of the coercive force and saturation magnetization of the magnetic powder, and that slow oxidation treatment improved handling properties.

### Reference Examples 9 to 12

### Preparation Examples Employing Barium Ferrite as the Hard Magnetic Phase

Magnetic powder comprised of gatheing particles of barium ferrite (referred to as “BaFe” hereinafter) (Hc: 270 kA/m, saturation magnetization: 5.2×10⁻² A·m²/g (52 emu/g), average plate diameter: 35 nm, average plate thickness: 8 nm) was immersed in the salt solution (1 gram of solution per gram of BaFe powder) described in Table 2 so as to wet the surface of the particles. The solvent was removed while reducing the pressure with an aspirator. In this process, the particles in the salt solution were stirred once every 30 minutes.

The dry powder obtained by removing the solvent was processed for one hour at 400° C. in a 4 volume percent methane 96 volume percent nitrogen gas flow to conduct reductive decomposition of the Co salt or the Fe salt contained in the deposition of the particle surface.

The above step yielded a magnetic powder comprised of gathering core/shell magnetic particles with cores in the form of BaFe hard magnetic phase and shells in the form of a Co or Fe-containing soft magnetic phase.

### Reference Comparative Example 2

With the exception that acetone was used instead of salt solution, magnetic powders were obtained by the same processing as in Reference Examples 9 and 10.

### Reference Comparative Example 3

With the exception that ethanol was used instead of the salt solution, magnetic powder was obtained by the same processing as in Reference Examples 11 and 12.

Since no salt solution was employed in Reference Comparative Example 2 or 3, BaFe magnetic particles were obtained that had no shells.

### Evaluation Methods (Evaluation of Magnetic Characteristics)

The magnetic characteristics of the magnetic powders comprised of core/shell magnetic particles obtained in Reference Examples 9 to 12 and the magnetic powders of Reference Comparative Examples 2 and 3 were evaluated under conditions of an applied magnetic field of 3,184 kA/m (40 kOe) with a superconducting vibrating sample magnetometer (VSM) made by Tamagawa Co. To prevent fast oxidation, the various magnetic powders were sealed in acrylic containers in nitrogen atmospheres for evaluation.

TABLE 2

| | | Quantity | | |
|---|---|---|---|---|
| | | of salt | | |
| | | per 100 g of | | |
| | | solution | Coercive | Saturation |
| Sample | Salt/solvent | (mmol) | force | magnetization |
| Ref. | Cobalt chloride/ | 2 | 235 kA/m | 0.56 × 10⁻¹ |
| Ex. 9 | acetone | | (2950 Oe) | A · m²/g |
| | | | | (56 emu/g) |
| Ref. | Cobalt chloride/ | 8 | 227 kA/m | 0.55 × 10⁻¹ |
| Ex. 10 | acetone | | (2850 Oe) | A · m²/g |
| | | | | (55 emu/g) |
| Ref. | Iron chloride/ | 2 | 231 kA/m | 0.55 × 10⁻¹ |
| Ex. 11 | ethanol | | (2900 Oe) | A · m²/g |
| | | | | (55 emu/g) |
| Ref. | Iron chloride/ | 8 | 223 kA/m | 0.54 × 10⁻¹ |
| Ex. 12 | ethanol | | (2800 Oe) | A · m²/g |
| | | | | (54 emu/g) |
| Ref. | None/acetone | 0 | 271 kA/m | 0.51 × 10⁻¹ |
| Comp. Ex. 2 | | | (3400 Oe) | A · m²/g |
| | | | | (51 emu/g) |
| Ref. | None/ethanol | 0 | 267 kA/m | 0.52 × 10⁻¹ |
| Comp. Ex. 3 | | | (3350 Oe) | A · m²/g |
| | | | | (52 emu/g) |

### Evaluation Results

In the evaluation of the above magnetic characteristics, the fact that no shift corresponding to the coercive force of the soft magnetic phase appeared in the hysteresis loops obtained by evaluation of the magnetic characteristics of Reference Examples 9 to 12 was confirmed. From these results, it was determined that magnetic particles in which a soft magnetic phase and a hard magnetic phase had exchange-coupled had been obtained in Reference Examples 9 to 12. In Table 2, the magnetic powders of Reference Comparative Examples 2 and 3 exhibited coercive force nearly equivalent to that of the unprocessed BaFe powder. By contrast, the fact that the coercive force of the magnetic powders of Reference Examples 9 to 12 was lower than the coercive force (270 kA/m) of the unprocessed BaFe powder was the result of exchange coupling of the soft magnetic phase and the hard magnetic phase on the surface of the BaFe particles (hard magnetic phase) in the magnetic powders of Reference Example 9 to 12. This result indicated improved recording properties. In the magnetic powders of Reference Examples 9 to 12, the saturation magnetization was higher than that of the unprocessed BaFe powder as indicated in Table 2. This result also indicated that the recording properties had been improved through exchange coupling of the hard magnetic phase and the soft magnetic phase.

### Evaluation Method (Gradient of Attenuation of Magnetization Over Time, Activation Volume)

The gradient of attenuation of magnetization over time due to demagnetizing fields of 400 Oe (about 32 kA/m) and 600 Oe (about 48 kA/m) corresponding to the demagnetizing fields to which a magnetic recording medium is subjected during storage, and the activation volume for a demagnetizing field of 500 Oe (about 40 kA/m) were calculated by the following procedure with a superconducting electromagnet vibrating sample magnetometer (model TM-VSM1450-SM made by Tamagawa Co.) for the magnetic powders of Reference Examples 9 to 12 and Reference Comparative Examples 2 and 3. In each measurement, the sample employed was 0.1 g of magnetic powder that was compacted in a measurement holder.

### (1) Gradient of Attenuation of Magnetization Over Time

In the case of thermal fluctuation magnetic aftereffects, ΔM/(Int₁-Int₂) becomes constant in the attenuation of magnetization over time. Since magnetization also varies depending on the magnetic field, the gradient of the attenuation of magnetization over time was determined by measuring the magnetization once each increment of time after the magnetic field had been stabilized.

Specifically, an external magnetic field of 40 kOe (about 3,200 kA/m) was applied to the sample. Following direct-current erasure, the magnet was controlled by means of current and current was supplied to generate the target demagnetizing field. The external magnetic field was gradually brought closer to the target demagnetizing field. This was to prevent the attenuation of magnetization over time from appearing to decrease due to stable processing by varying the external magnetic field.

Designating the time when the magnetic field had reached the target value as the base point in measurement, the magnetization was measured for 25 minutes once every 1 minute and the gradient of the attenuation of magnetization over time ΔM/(Int₁-Int₂) was obtained. The results are given in Table 3. In Table 3, the value given was obtained by dividing ΔM/(Int₁-Int₂) by the magnetization in a 40 kOe external magnetic field and normalizing the result.

### (2) Activation Volume

The magnetization was calculated 25 minutes after the target demagnetizing field was reached by the same procedure as in (1) above for demagnetizing fields H1 (400 Oe) and H2 (600 Oe) differing only by 200 Oe (about 16 kA/m). These magnetization levels were denoted as M_{B} and M_{E}, respectively, giving a total magnetization rate of Xtot=(M_{B}−M_{E})/ΔH=(M_{B}−M_{E})/200.

Next, reversible magnetization rate Xrev was obtained from Xrev=(M_{F}−M_{E})/ΔH=(M_{F}−M_{E})/200 by calculating the magnetization M_{F} when the external magnetic field from H2 was increased by 200 Oe.

Irreversible magnetization rate (Xirr) was obtained from Xirr=Xtot−Xrev.

The activation volume (Vact) was calculated from Vact=kT/(Ms(ΔM/Xirr(Int₁-Int₂)). In the above equation, k: Boltzmann constant; T: temperature; Ms: saturation magnetization of the sample.

Based on the above step, the activation volume was obtained at a demagnetization field of 500 Oe. The results are given in Table 3.

TABLE 3

| | Gradient of attenuation of | | |
|---|---|---|---|
| | magnetization over time | | Activation volume |
| | (l/ln(s)) | | (nm³) |
| | Demagnetizing | Demagnetizing | Demagnetizing |
| | field | field | field |
| | 400 Oe | 600 Oe | 500 Oe |
| Ref. Ex. 9 | −0.0030 | −0.0038 | 3000 |
| Ref. Ex. 10 | −0.0033 | −0.0030 | 2900 |
| Ref. Ex. 11 | −0.0033 | −0.0033 | 3100 |
| Ref. Ex. 12 | −0.0038 | −0.0038 | 2950 |
| Ref. Comp. Ex. 2 | −0.0030 | −0.0038 | 3000 |
| Ref. Comp. Ex. 3 | −0.0033 | −0.0033 | 2900 |

### Evaluation Results

The gradient of the attenuation of magnetization over time as measured by the above-described method is an index of the thermal stability of magnetic particles. As shown in Table 3, the gradient of the attenuation of magnetization over time of the magnetic powders of Reference Examples 9 to 12 were nearly equivalent to those of Reference Comparative Examples 2 and 3. From these results, it can be determined that exchange coupling of the hard magnetic phase and soft magnetic phase maintained the thermal stability of the magnetic particles without loss. Such magnetic particles with high thermal stability and little attenuation of magnetization over time can provide a magnetic recording medium with high reliability in which attenuation of recorded signals is small.

Further, the activation volume shown in Table 3 is an index of the presence or absence of aggregation. If aggregation were to have been present, a change would have appeared in the thousands place or higher. However, as shown in Table 3, the activation volumes of Reference Examples 9 to 12 were nearly equivalent to those of Reference Comparative Examples 2 and 3. From these results, it can be determined that no aggregation was produced in the step of exchange coupling the hard magnetic phase and the soft magnetic phase. From the above evaluation results, it can be determined that the magnetic particles in which a hard magnetic phase was exchange-coupled with a soft magnetic phase had good thermal stability, were microparticles that were nearly equivalent to hard magnetic particles prior to the formation of a soft magnetic phase, and were thus suited to high-density recording.

Errors in the hundreds place are known to occur in the activation volume. The numeric values of the activation voltage indicated in Table 3 were nearly equivalent for Reference Examples 9 to 12 and Reference Comparative Examples 2 and 3. However, in reality, the magnetic particles prepared in Reference Examples 9 to 12 were thought to have greater volume by the amount of the shell that was present than the magnetic particles prepared in Reference Comparative Examples 2 and 3. The reason this increase in volume was not reflected in the numeric values of the activation volume was presumed to be that the amount of the volume increase was buried in the above error portion.

### Evaluation of the Suitability of the Reducing Gas

BaFe powder comprised of the particles of BaFe (Hc: 270 kA/m, saturation magnetization: 5.2×10⁻² A·m²/g (52 emu/g), average plate diameter: 35 nm, average plate thickness: 8 nm) employed as the hard magnetic particles in Reference Examples 9 to 12 was annealed for 10 minutes at the temperature given in Table 4 in the gas flow indicated in Table 4, after which the saturation magnetization was measured by the above-described method. The results are given in Table 4.

TABLE 4

| | Reducing gas | | |
|---|---|---|---|
| | H₂ | CH₄ | 10 vol % CO + 90 vol % N₂ |
| No annealing | 0.52 × 10⁻¹ | — | — |
| | A · m²/g | | |
| | (52 emu/g) | | |
| Annealing | 0.44 × 10⁻¹ | 0.52 × 10⁻¹ | 0.46 × 10⁻¹ |
| at 200° C. | A · m²/g | A · m²/g | A · m²/g |
| | (44 emu/g) | (52 emu/g) | (46 emu/g) |
| Annealing | 0.31 × 10⁻¹ | 0.51 × 10⁻¹ | 0.26 × 10⁻¹ |
| at 300° C. | A · m²/g | A · m²/g | A · m²/g |
| | (31 emu/g) | (51 emu/g) | (26 emu/g) |
| Annealing | 0.72 × 10⁻¹ | 0.51 × 10⁻¹ | 0.58 × 10⁻¹ |
| at 400° C. | A · m²/g | A · m²/g | A · m²/g |
| | (72 emu/g) | (51 emu/g) | (58 emu/g) |

### Evaluation Results

As indicated in Table 4, for the barium ferrite that was annealed in a hydrogen gas flow or in a carbon monoxide/nitrogen mixed gas flow, the saturation magnetization decreased up to an annealing temperature of 300° C. and the saturation magnetization increased at an annealing temperature of 400° C. This was presumed to be because the barium ferrite was reduced and decomposed due to the high reducing strength of hydrogen and carbon monoxide.

By contrast, barium ferrite that was annealed in a methane gas flow exhibited almost no change in saturation magnetization due to differences in the annealing temperature. This was attributed to the fact that barium ferrite was stable in the methane gas flow, and was not reduced or decomposed.

In the course of manufacturing the core/shell magnetic particles in which a hard magnetic phase is exchange-coupled with a soft magnetic phase by the manufacturing method set forth above, the entire surface of the hard magnetic particles is not exposed to the reducing gas in the manner of the above evaluation because the reductive decomposition are conducted in a reducing gas atmosphere after the deposition containing a transition metal salt has been formed on the surface of the hard magnetic particles. However, since barium ferrite is presumed to have the property of being readily decomposed by reduction based on the above evaluation results, when a reducing gas of high reducing strength is employed, there is a possibility that even the area beneath the deposition will be decomposed by reduction and that magnetic characteristics such as the saturation magnetization will change. Accordingly, when employing an oxide such as barium ferrite as the hard magnetic particle, it is desirable to employ a reducing gas of relatively low reducing strength. From this perspective, a hydrocarbon, particularly methane, is desirably employed. Alternatively, hydrogen of great reducing strength is desirably employed by diluting it with an inert gas.

### Reference Example 13

### Example Employing Barium Ferrite as Hard Magnetic Phase

Magnetic powder comprised of gathering BaFe particles (Hc: 247 kA/m (3,100 Oe), saturation magnetization: 4.6×10⁻² A·m²/g (46 emu/g), average plate diameter: 20.6 nm, average plate thickness: 6.1 nm, particle volume: 1,680 nm³) was immersed (3 g of solution per gram of magnetic particles) in 6 weight percent cobalt chloride solution (solvent: acetone) in such a manner as to wet the surface of the particles. The solvent was removed while reducing the pressure with an aspirator. In this process, the particles in the cobalt chloride solution were stirred once every 30 minutes.

The dry powder obtained by removing the solvent was treated for 17 hours at 350° C. in a 4 volume percent methane and 96 volume percent nitrogen gas flow to conduct reductive decomposition of the Co salt contained in the deposition of the particle surface.

The above steps yielded core/shell magnetic particles with cores of BaFe hard magnetic phase and shells of Co-containing soft magnetic phase.

### Evaluation Method

(1) Evaluation of the Composition by Scanning Transmission Electron Microscope (STEM)

The Co/Ba ratio and Cl/Ba ratio (both atomic ratios) of the magnetic particles obtained and of untreated starting material BaFe particles for reference were measured with a model HD2300 STEM (200 kV) made by Hitachi. The results are given in Table 5 below.

TABLE 5

| | Composition ratio | |
|---|---|---|
| Sample | Co/Ba | Cl/Ba |
| Untreated BaFe | 0 | 0 |
| (Reference) | | |
| Ex. 13 | 1.7 | 0.5 |

(2) Composition Evaluation by X-Ray Diffraction

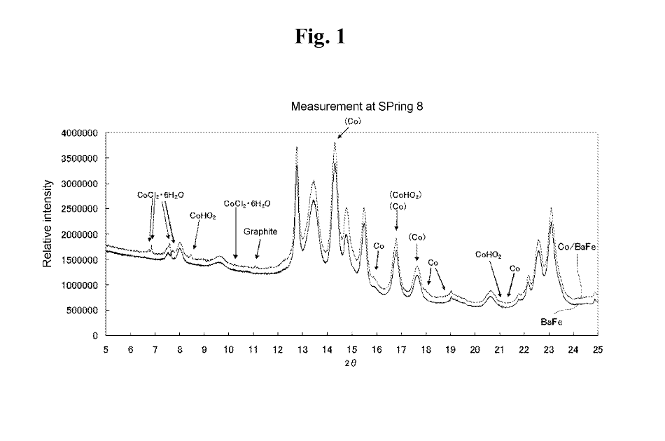

The composition of the magnetic particles obtained and of untreated starting material BaFe particles for reference was evaluated by X-ray diffraction analysis with a SPring-8 (Nb K edge wavelength 0.65297 Angstrom). The results are given in FIG. 1. The X-ray diffraction peaks were assigned using a library based on elements that could have potentially entered the test process.

(3) Coercive Force Evaluation

Evaluation of the coercive force of the magnetic powder comprised of the core/shell magnetic particles obtained in Reference Example 13 under conditions of an applied magnetic field of 3,184 kA/m (40 kOe) with a superconducting vibrating sample magnetometer (VSM) made by Tamagawa Co. revealed a value of 146 kA/m (1,830 Oe). To prevent fast oxidation, the magnetic powder was sealed in an acrylic container in a nitrogen atmosphere for evaluation.

### Evaluation Results

As shown in Table 5, in contrast to no detection of Co in the starting material BaFe powder, Co and CoHO₂, the latter being a compound of cobalt, oxygen, and hydrogen, were detected in the magnetic powder obtained in Reference Example 13. These results confirmed the fact that Co and CoHO₂ were deposited on the surface of the hard magnetic particles as a soft magnetic phase in Reference Example 13. Since the transition metal salt employed to form the deposition in Reference Example 13 did not contain an alkaline earth metal, neither did the soft magnetic phase that was formed. Since peaks were detected by X-ray diffraction, it was possible to confirm that Co and CoHO₂ were deposited as crystalline substances.

Since the coercive force of the magnetic powder of Reference Example 13 was lower than that of the starting material BaFe powder, the presence of a soft magnetic phase exchange-coupled to a hard magnetic phase on the surface of the hard magnetic particles (hard magnetic phase) was confirmed in the magnetic powder of Reference Example 13. As shown in Table 5, the presence of Cl in the magnetic powder of Example 13 was also confirmed. However, it was confirmed from the peak in the X-ray diffraction of FIG. 1 that this was caused by a portion of the cobalt chloride employed as a starting material of the soft magnetic phase remaining unreacted. When a portion of the starting material transition metal salt remained in the magnetic particles following reductive decomposition in this manner, washing and removing it with the solvent (acetone in Reference Example 13) employed to prepare the solution of the transition metal salt, for example, was desirable to obtain magnetic particles with good magnetic characteristics. Although peaks corresponding to Co and Co salt appeared in the spectrum of the starting material BaFe powder shown in FIG. 1, they were background, and did not indicate that Co and Co salt were present in the starting material BaFe powder.

Further, the specific peak of graphite, which did not appear in the starting material BaFe powder, was detected in the magnetic powder of Reference Example 13 as shown in FIG. 1. Based on these results, it was determined that conducting gas phase reductive decomposition in a hydrocarbon-containing (methane-containing) atmosphere yielded magnetic particles with a carbon component (graphite) present in the outermost layer.

### Examples 1 to 4

### Comparative Examples 1 and 2

(1) Formula of Magnetic Layer Coating Liquid

| | |
|---|---|
| Magnetic powder indicated in Table 6 | 100 parts |
| Polyurethane resin | 15 parts |
| Branched side chain-containing polyester polyol/diphenyl | |
| methane diisocyanate based polyurethane resin, —SO₃Na = 400 | |
| eq/ton | |
| α-Al₂O₃ (particles size 0.15 μm) | 4 parts |
| Plate-shaped alumina powder (average particle diameter: 50 nm) | 0.5 part |
| Diamond powder (average particle diameter: 60 nm) | 0.5 part |
| Carbon black (particle size 20 nm) | 1 part |
| Cyclohexanone | 110 parts |
| Methyl ethyl ketone | 100 parts |
| Toluene | 100 parts |
| Butyl stearate | 2 parts |
| Stearic acid | 1 part |

(2) Formula of Nonmagnetic Layer Coating Liquid

| | |
|---|---|
| Nonmagnetic inorganic particle α-iron oxide | 85 parts |
| Surface treatment agents: Al₂O₃, SiO₂ | |
| Major axis diameter: 0.15 μm | |
| Tap density: 0.8 | |
| Acicular ratio: 7 | |
| BET specific surface area: 52 m²/g | |
| pH: 8 | |
| DBP oil absorption capacity: 33 g/100 g | |
| Carbon black | 15 parts |
| DBP oil absorption capacity: 120 mL/100 g | |
| pH: 8 | |
| BET specific surface area: 250 m²/g | |
| Volatile content: 1.5 percent | |
| Polyurethane resin | 22 parts |
| Branched side chain-containing polyester polyol/diphenyl | |
| methane diisocyanate based polyurethane resin , —SO₃Na = 200 | |
| eq/ton | |
| Phenyl phosphonic acid | 3 parts |
| Cyclohexanone | 140 parts |
| Methyl ethyl ketone | 170 parts |
| Butyl stearate | 2 parts |
| Stearic acid | 1 part |

(3) Formula of Backcoat Layer Coating Liquid

| | |
|---|---|
| Carbon black (average particle diameter: 25 nm) | 40.5 parts |
| Carbon black (average particle diameter: 370 nm) | 0.5 part |
| Barium sulfate | 4.05 parts |
| Nitrocellulose | 28 parts |
| Polyurethane resin (containing SO₃Na groups) | 20 parts |
| Cyclohexanone | 100 parts |
| Toluene | 100 parts |
| Methyl ethyl ketone | 100 parts |

(4) Preparation of Coating Liquids for Forming Various Layers

The various components of each of the magnetic layer coating liquid, nonmagnetic layer coating liquid, and backcoat layer coating liquid of the above formulas were separately placed in an open kneader and kneaded for 240 minutes, dispersed in a bead mill (the magnetic layer coating liquid for 1,440 minutes, the nonmagnetic layer coating liquid for 720 minutes, and the backcoat coating liquid for 720 minutes). To each of the dispersions obtained were added four parts of a trifunctional low-molecular-weight polyisocyanate compound (Coronate 3041, made by Nippon Polyurethane Industry Co., Ltd.), the mixture was stirred and mixed for another 20 minutes, and filtration was conducted with a filter having an average pore diameter of 0.5 μm. Subsequently, the magnetic layer coating liquid was centrifugally separated for 30 minutes at a rotational speed of 10,000 rpm in a Himac CR-21D cooled centrifugal separator made by Hitachi Hitec and graded to remove the aggregate material.

(5) Preparation of Magnetic Tape

The nonmagnetic layer coating liquid obtained was coated in a quantity calculated to yield a dry thickness of 1.5 μm on a PEN support 5 μm in thickness (average surface roughness Ra=1.5 nm as measured by an HD2000 made by WYKO) and dried at 100° C. to obtain a nonmagnetic layer. The support stock material on which the nonmagnetic layer had been formed was heat treated for 24 hours at 70° C. Subsequently, following the grading, the magnetic layer coating liquid was wet-on-dry coated on the nonmagnetic layer in a quantity calculated to yield a 20 nm thickness upon drying, and then dried at 100° C. The backcoat layer coating liquid was applied to the opposite surface of the support from that on which the magnetic layer had been provided, and dried to form a 0.5 μm backcoat layer.

Subsequently, a surface smoothing treatment was conducted at a temperature of 100° C. at a linear pressure of 350 kg/cm at a rate of 100 m/min with a seven-stage calender comprised solely of metal rolls and the product was slit to ½ inch to prepare a magnetic tape.

(6) Evaluation of Magnetic Tape

### (6-1) Coercive Force

The coercive force was evaluated under conditions of an applied magnetic field of 3,184 kA/m (40 kOe) with a vibrating sample magnetometer (VSM) made by Tamakawa Co., Ltd.

### (6-2) Electromagnetic Characteristics (ORC, SNR)

The electromagnetic characteristics were measured by the following method with a drum tester (relative velocity 5 m/s).

### 1) ORC

A write head with a gap length of 0.2 μm and Bs=1.6 T was employed to record a signal at a linear recording density of 275 kFCI and a GMR head (Tw width 3 μm, sh-sh=0.18 μm) was used to reproduce the signal. In this process, the recording current was varied and the current at which the output peaked was adopted as the optimal recording current (ORC).

### 2) SNR

Under the conditions set forth in 1) above, the signal was recorded and reproduced at the ORC determined in 1) above and the ratio of the 0 to 2×275 kFCI integral noise to the 275 kFCI output was measured.

The results of the above are given in Table 6. The SNR given in Table 6 is denoted as the relative value using the value measured for the magnetic tape of Comparative Example 1 as a base.

TABLE 6

| | | Coercive | | |
|---|---|---|---|---|
| | Magnetic | force of | ORC | SNR |
| | powder | medium | (mA) | (dB) |
| Ex. 1 | Ref. Ex. 9 | 267 kA/m | 15.0 | 2.0 |
| | | (3360 Oe) | | |
| Ex. 2 | Ref. Ex. 10 | 255 kA/m | 14.5 | 2.5 |
| | | (3200 Oe) | | |
| Ex. 3 | Ref. Ex. 11 | 261 kA/m | 15.0 | 1.7 |
| | | (3280 Oe) | | |
| Ex. 4 | Ref. Ex. 12 | 248 kA/m | 14.0 | 2.7 |
| | | (3120 Oe) | | |
| Comp. Ex. 1 | Ref. Comp. | 326 kA/m | 19.0 | 0 |
| | Ex. 2 | (4100 Oe) | | |
| Comp. Ex. 2 | Ref. Comp. | 319 kA/m | 18.0 | 0.5 |
| | Ex. 3 | (4010 Oe) | | |

As shown in Table 3 above, the magnetic powders of Reference Examples 9 to 12 had high thermal stability and could provided magnetic recording media of little attenuation of magnetization over time and high reliability. As shown in Table 6, the magnetic tapes of Examples 1 to 4 that were prepared using these magnetic powders exhibited higher SNRs at lower recording currents than the magnetic tapes of Comparative Examples 1 and 2, which were prepared using BaFe particles that were not deposited with a soft magnetic phase.

The above results show that the present invention can provide a particulate magnetic recording medium that affords both good recording properties and high reliability.

### Reference Examples 14 and 15

The barium ferrite indicated in Table 7 below (described as “BaFe”, hereinafter, with a ferrite composition of BaFe₁₂O₁₉) was immersed (1 g of solution per gram of BaFe powder) so as to wet the particle surface in a salt solution of a concentration that would coat the Co salt or Fe salt in the quantity indicated in Table 8. While reducing the pressure with an aspirator, the solvent was removed. During this process, the particles in the salt solution were stirred every 30 minutes.

The dry powder obtained by removing the solvent was processed for one hour at 200° C. in a 4 vol % hydrogen, 96 vol % nitrogen gas flow to reduction decompose the Co salt or Fe salt contained on the particle surface.

By means of the above steps, magnetic powders comprised of gathering core/shell magnetic particles having a core in the form of a BaFe hard magnetic phase and a shell in the form of a Co or Fe-containing soft magnetic phase were obtained.

### Reference Examples 16 and 17

With the exception that the treatment conducted for one hour at 200° C. in a 4 vol % hydrogen, 96 vol % nitrogen gas flow was changed to the treatment conducted for one hour at 400° C. in a 4 vol % methane, 96 vol % nitrogen gas flow, magnetic powders comprised of gathering core/shell magnetic particles having a core in the form of a BaFe hard magnetic phase and a shell in the form of a Co or Fe-containing soft magnetic phase were obtained in the same manner as in Reference Examples 14 and 15.

TABLE 7

| | | | Average | Coercive |
|---|---|---|---|---|
| | Average plate | Average plate | particle volume | force |
| S_{BET} (m²/g) | diameter (nm) | thickness (nm) | (nm³) | Hc |
| 79.5 | 20.6 | 6.1 | 1,681 | 3180 Oe |
| | | | | (253 kA/m) |

Method of Evaluating the Magnetic Powders

### (1) Specific Surface Area S_{BET}

The S_{BET} indicated in Table 7 was measured by the nitrogen adsorption method.

### (2) Evaluation of Particle Size (Average Plate Diameter, Average Plate Thickness, and Average Particle Volume by TEM Observation)

The measurements of the particle size given in Table 7 were made with a TEM made by Hitachi (applied voltage 200 kV).

### (3) Magnetic Characteristics (Coercive Force Hc, Saturation Magnetization Ms)

The coercive force Hc and saturation magnetization Ms of the magnetic powder of starting material BaFe were evaluated under conditions of an applied magnetic field of 3,184 kA/m (40 kOe) using a vibrating sample magnetometer (VSM) made by Tamakawa Co., Ltd. The results are given in Table 7. The magnetic characteristics of the magnetic powders obtained in Reference Examples 14 to 17 were also measured by the same method. The results are given in Table 8.

TABLE 8

| | | Transition | | | |
|---|---|---|---|---|---|
| | | metal salt | | | |
| | | depositing | | | Saturation |
| | | per gram of | Reducing | | magnet- |
| | Salt/ | BaFe | gas | Coercive | ization |
| | solvent | (mol) | employed | force | Ms |
| Ref. Ex. 14 | Cobalt | 6.75 × 10⁻⁵ | 4 vol % of | 2280 Oe | 0.42 × 10⁻¹ |
| | chloride/ | | hydrogen | (181 kA/m) | A · m²/g |
| | acetone | | | | (42 emu/g) |
| Ref. Ex. 15 | Iron | 9.05 × 10⁻⁴ | 4 vol % of | 2510 Oe | 0.40 × 10⁻¹ |
| | chloride/ | | hydrogen | (200 kA/m) | A · m²/g |
| | ethanol | | | | (40 emu/g) |
| Ref. Ex. 16 | Cobalt | 6.75 × 10⁻⁵ | 4 vol % of | 2490 Oe | 0.43 × 10⁻¹ |
| | chloride/ | | methane | (198 kA/m) | A · m²/g |
| | acetone | | | | (43 emu/g) |
| Ref. Ex. 17 | Iron | 9.05 × 10⁻⁴ | 4 vol % of | 2780 Oe | 0.40 × 10⁻¹ |
| | chloride/ | | methane | (221 kA/m) | A · m²/g |
| | ethanol | | | | (40 emu/g) |

Since the coercive forces of the magnetic powders of Reference Examples 14 to 17 were lower than those of the starting material BaFe shown in Table 7, the presence of a soft magnetic phase, exchange-coupled with a hard magnetic phase, on the surface of the hard magnetic particle (hard magnetic phase) was confirmed in the magnetic powders of Reference Examples 14 to 17.

The magnetic powders of Reference Examples 14 to 17 were subjected to X-ray diffraction analysis. When the X-ray diffraction peaks were assigned using a library based on the elements available in the testing process, no peaks derived from carbon components were detected in the magnetic particles of Reference Examples 14 and 15. By contrast, graphite peaks were detected in Reference Examples 16 and 17. This difference was due to the different reducing gases employed. Based on these results, it was determined that by using hydrogen as the reducing gas, it was possible to obtain magnetic particles in which no peak derived from a carbon component was detected by X-ray diffraction analysis. It was confirmed by X-ray diffraction that the magnetic powders of Reference Examples 14 to 17 exhibited the crystalline structure of hexagonal ferrite.

### Example 5

### 1-1. Formula of Magnetic Layer Coating Liquid

| | |
|---|---|
| Magnetic powder of Reference Example 14 | 100 parts |
| Polyurethane resin | 14 parts |
| (Functional group: —SO₃Na, functional group concentration: | |
| 180 eq/t) | |
| Oleic acid | 1.5 parts |
| 2,3-Dihydroxynaphthalene | 6 parts |
| Alumina powder (average particle diameter: 120 nm) | 6 parts |
| Silica colloidal particles | 2 parts |
| (Colloidal silica: average particle size 100 nm) | |
| Cyclohexanone | 110 parts |
| Methyl ethyl ketone | 100 parts |
| Toluene | 100 parts |
| Butyl stearate | 2 parts |
| Stearic acid | 1 part |

### 1-2. Formula of Nonmagnetic Layer Coating Liquid

| | |
|---|---|
| Nonmagnetic inorganic powder (α-iron oxide) | 85 parts |
| Surface treatment agents: Al₂O₃, SiO₂ | |
| Major axis diameter: 0.05 μm | |
| Tap density: 0.8 | |
| Acicular ratio: 7 | |
| BET specific surface area: 52 m²/g | |
| pH: 8 | |
| DBP oil absorption capacity: 33 g/100 g | |
| Carbon black | 20 parts |
| DBP oil absorption capacity: 120 mL/100 g | |
| pH: 8 | |
| BET specific surface area: 250 m²/g | |
| Volatile content: 1.5 percent | |
| Polyurethane resin | 15 parts |
| (Functional group: —SO₃Na, functional group concentration: | |
| 180 eq/t) | |
| Phenyl phosphonic acid | 3 parts |
| α-Al₂O₃ (average particle diameter: 0.2 μm) | 10 parts |
| Cyclohexanone | 140 parts |
| Methyl ethyl ketone | 170 parts |
| Butyl stearate | 2 parts |
| Stearic acid | 1 part |

### 1-3. Preparation of Magnetic Tape

The various components of each of the above coating liquids were separately placed in an open kneader, kneaded for 60 minutes, and then dispersed in a sand mill for 720 to 1,080 minutes using zirconia beads (particle diameter 0.5 mm or 0.1 mm). To each of the dispersions obtained were added six parts of a trifunctional low-molecular-weight polyisocyanate compound (Coronate 3041, made by Nippon Polyurethane Industry Co., Ltd.), the mixtures were stirred and mixed for another 20 minutes, and filtration was conducted with a filter having an average pore diameter of 1 μm to prepare a magnetic layer coating liquid and nonmagnetic layer coating liquid.

The nonmagnetic layer coating liquid was coated in a quantity calculated to yield a dry thickness of 1.5 μm on a polyethylene naphthalate base 5 μm in thickness and dried at 100° C. Immediately thereafter, the magnetic layer coating liquid was wet-on-dry coated in a quantity calculated to yield a dry thickness of 0.08 μm, and then dried at 100° C. At that time, the magnetic layer was oriented with a vertical magnetic field while still in a wet state using a 300 mT (3,000 gauss) magnet. Subsequently, a surface smoothing treatment was conducted at a temperature of 90° C. at a linear pressure of 300 kg/cm at a rate of 100 m/min with a seven-stage calender comprised solely of metal rolls. The product was then heat treated for 24 hours at 70° C., and slit to ½ inch to prepare a magnetic tape.

### Example 6

With the exception that 100 parts of the magnetic powder of Reference Example 15 were employed as the ferromagnetic powder, a magnetic tape was prepared by the same method as in Example 5.

### Example 7

With the exception that the colloidal silica was left out of the magnetic layer components, a magnetic tape was prepared by the same method as in Example 5.

### Example 8

With the exception that 20 parts of carbon black with an average particle size of 15 nm were employed instead of the 20 parts of colloidal silica as a magnetic layer component, a magnetic tape was prepared by the same method as in Example 5.

### Example 9

With the exception that the 2,3-dihydroxynaphthalene was left out of the magnetic layer components, a magnetic tape was prepared by the same method as in Example 8.

### Example 10

With the exception that the 2,3-dihydroxynaphthalene was left out of the magnetic layer components, a magnetic tape was prepared by the same method as in Example 5.

### Example 11

With the exception that 100 parts of the magnetic powder of Reference Example 16 were employed as the ferromagnetic powder, a magnetic tape was prepared by the same method as in Example 5.

### Example 12

With the exception that 100 parts of the magnetic powder of Reference Example 17 were employed as the ferromagnetic powder, a magnetic tape was prepared by the same method as in Example 5.

Methods of Evaluating the Magnetic Tapes

### (1) Magnetic Characteristics

The coercive force Hc of the magnetic tapes was evaluated under conditions of an applied magnetic field of 3,184 kA/m (40 kOe) with a vibrating sample magnetometer (VSM) made by Tamakawa Co., Ltd. The results are given in Table 9.

### (2) Magnetic Layer Surface Roughness Ra

An area measuring 40 μm×40 μm of the surface of the magnetic layer was measured with an atomic force microscope (AFM: Nanoscope III made by Digital Instruments) in contact mode, and the centerline average surface roughness (Ra) was measured. The results are given in Table 9.

### (3) Measuring the Coefficient of Friction

The coefficient of friction (μ value) was determined when the surface of the magnetic layer of a magnetic tape was weighted with 100 g and repeatedly slid back and forth 100 times at a rate of 10 mm/s against a cylindrical SUS rod with a centerline average surface roughness of Ra of 5 nm as measured by AFM. The results are given in Table 9. In Table 9, the heading “Stuck” means that the coefficient of friction was excessively high and the cylindrical SUS rod ended up sticking to the magnetic layer surface, making it difficult for the surface to slide back and forth.

TABLE 9

| | | | Coefficient of | Coercive | | |
|---|---|---|---|---|---|---|
| | Magnetic | | friction-lowering | force | | μ |
| | powder | Surface modifier | component | of tape | Ra (nm) | value |
| Ex. 5 | Ref. Ex. 14 | 2,3- | Colloidal silica | 2350 Oe | 1.8 | 0.23 |
| | | dihydroxynaphthalene | | (187 kA/m) | | |
| Ex. 6 | Ref. Ex. 15 | 2,3- | Colloidal silica | 2700 Oe | 1.8 | 0.22 |
| | | dihydroxynaphthalene | | (215 kA/m) | | |
| Ex. 7 | Ref. Ex. 14 | 2,3- | — | 2360 Oe | 1.8 | Stuck |
| | | dihydroxynaphthalene | | (188 kA/m) | | |
| Ex. 8 | Ref. Ex. 14 | 2,3- | Carbon black | 2340 Oe | 2.8 | 0.19 |
| | | dihydroxynaphthalene | | (186 kA/m) | | |
| Ex. 9 | Ref. Ex. 14 | — | Carbon black | 2350 Oe | 2.9 | 0.2 |
| | | | | (187 kA/m) | | |
| Ex. 10 | Ref. Ex. 14 | — | Colloidal silica | 2360 Oe | 3 | 0.19 |
| | | | | (188 kA/m) | | |
| Ex. 11 | Ref. Ex. 16 | 2,3- | Colloidal silica | 2650 Oe | 3.1 | 0.18 |
| | | dihydroxynaphthalene | | (211 kA/m) | | |
| Ex. 12 | Ref. Ex. 17 | 2,3- | Colloidal silica | 3100 Oe | 2.9 | 0.19 |
| | | dihydroxynaphthalene | | (247 kA/m) | | |

Evaluation Results

As set forth above, the lower the coercive force, the smaller the external magnetic field that was required for recording, which is advantageous from the perspective of the recording properties (ease of recording). All of the magnetic powders prepared in Reference Examples 14 to 17 exhibited coercive forces that were lower than that of the starting material BaFe. Thus, an improvement in the recording properties due to the processing conducted in Reference Examples 14 to 17 was confirmed. Further, as set forth above, the magnetic powders of Reference Examples 14 to 17 had a hexagonal ferrite structure. Thus, they had the high thermal stability contributed by that structure. That is, the magnetic powders of Reference Examples 14 to 17 had high thermal stability and good recording properties.

From the perspective of inhibiting a drop in electromagnetic characteristics due to spacing fluctuation, the surface roughness of the magnetic layer surface is desirably low over the range at which running durability can be maintained. The magnetic layer surface roughness that is desirable in this regard is a surface roughness R^{a} as measured by the above method falling within a range of 1.0 to 2.0 nm. As shown in Table 9, Example 5 had greater magnetic layer surface smoothness than Examples 9 and 10, which contained the same ferromagnetic powders but did not contain 2,3-dihydroxynaphthalene, and exhibited a desirable surface roughness Ra. These results indicate that the surface modifier produced a dispersion-enhancing result. However, in Example 8, which contained magnetic layer components in the form of 2,3-dihydroxynaphthalene and carbon black, the ferromagnetic powder was identical but the smoothness of the magnetic layer surface was much lower than that of Example 5, in which colloidal silica was incorporated as a coefficient of friction-lowering component. Thus, the surface modifier was determined not to produce an adequate dispersion-enhancing effect when employed in combination with carbon black.

In Example 7, which did not contain colloidal silica as a magnetic layer component, back and forth sliding was difficult during measurement of the coefficient of friction. Thus, a coefficient of friction-lowering component was determined to be effective to enhance running durability. The reason surface smoothness decreased in Examples 11 and 12 relative to Examples 5 and 6, from which they differed in terms of the magnetic powder, was thought to be that the magnetic powder contained a carbon component, making it difficult to achieve an adequate dispersion-enhancing effect based on the surface modifier.

The object of the present invention, as set forth above, is to provide a particulate magnetic recording medium, containing magnetic particles of high thermal stability in the magnetic layer, and having good recording properties. This object can be achieved by employing a ferromagnetic powder in the form of magnetic particles comprising a hard magnetic particle and a soft magnetic material deposited on a surface of the hard magnetic particle in a state where the soft magnetic material is exchange-coupled with the hard magnetic particle. In addition, the fact that it is desirable to apply the surface modifier to a magnetic powder in which no carbon component is detected and to employ it in combination with nonmagnetic inorganic particles as a coefficient of friction-lowering component to obtain a magnetic recording medium of both good surface smoothness and friction characteristics was confirmed by comparing Examples 5 and 6 to Examples 7 to 12.

The magnetic recording medium of the present invention is optimal as a backup tape that is required to afford high reliability for an extended period.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A magnetic recording medium comprising a magnetic layer containing a ferromagnetic powder and a binder on a nonmagnetic support, wherein
the ferromagnetic powder is comprised of magnetic particles comprising a hard magnetic particle and a soft magnetic material deposited on a surface of the hard magnetic particle in a state where the soft magnetic material is exchange-coupled with the hard magnetic particle.

2. The magnetic recording medium according to claim 1, wherein the magnetic particle has a coercive force in a range of equal to or higher than 80 kA/m but less than 240 kA/m.

3. The magnetic recording medium according to claim 1, wherein the magnetic particle has a saturation magnetization ranging from 4.0×10⁻² to 2.2 A·m²/g.

4. The magnetic recording medium according to claim 1, wherein a carbon component is present over the hard magnetic particle on which the soft magnetic material is deposited.

5. The magnetic recording medium according to claim 1, wherein a carbon component is present in an outermost layer of the magnetic particle.

6. The magnetic recording medium according to claim 1, wherein the magnetic particle is a magnetic particle in which no peak derived from a carbon component is detected by X-ray diffraction analysis.

7. The magnetic recording medium according to claim 1, wherein the magnetic layer further comprises a component which lowers a coefficient of friction.

8. The magnetic recording medium according to claim 7, wherein
the component which lowers a coefficient of friction is a nonmagnetic inorganic particle, and
the magnetic layer further comprises an aromatic compound containing an aromatic ring in which a substituent selected from the group consisting of a hydroxyl group and a carboxyl group is directly substituted onto the aromatic ring.

9. The magnetic recording medium according to claim 7, wherein the magnetic layer comprises no carbon black.

10. The magnetic recording medium according to claim 8, wherein the magnetic layer further comprises a granular substance other than a carbon black, and the granular substance is different from the nonmagnetic inorganic particle.

11. The magnetic recording medium according to claim 8, wherein the nonmagnetic inorganic particle is an inorganic oxide colloidal particle.

12. The magnetic recording medium according to claim 11, wherein the inorganic oxide colloidal particle is a silica colloidal particle.

13. The magnetic recording medium according to claim 8, wherein the aromatic compound comprises one aromatic ring per molecule.

14. The magnetic recording medium according to claim 8, wherein the aromatic ring contained in the aromatic compound is a naphthalene ring or a biphenyl ring.

15. The magnetic recording medium according to claim 8, wherein the number of the substituent which is substituted onto the aromatic ring contained in the aromatic compound is one or two.

16. The magnetic recording medium according to claim 8, wherein the aromatic compound is dihydroxynaphthalene.

17. The magnetic recording medium according to claim 1, wherein the magnetic powder has an oxide layer over the hard magnetic particle on which the soft magnetic material is deposited.

18. The magnetic recording medium according to claim 1, wherein the hard magnetic particle is hexagonal ferrite.

19. The magnetic recording medium according to claim 1, wherein the soft magnetic material comprises a transition metal and a compound of a transition metal and oxygen.

20. The magnetic recording medium according to claim 19, wherein the compound comprises no alkaline earth metal.

21. The magnetic recording medium according to claim 19, wherein the transition metal contained in the compound is cobalt.

22. The magnetic recording medium according to claim 21, wherein the compound is CoHO₂.
